(19) United States
(12) Patent Application Publication
(10) Pub. No.: US 2019/0340554 A1
(43) Pub. Date: Nov. 7, 2019

(54) ENGAGEMENT LEVELS AND ROLES IN PROJECTS

(71) Applicant: MICROSOFT TECHNOLOGY LICENSING, LLC, Redmond, WA (US)

(72) Inventors: Dikla Dotan-Cohen, Herzelia (IL); Boaz Sapir, Givatayim (IL); Omri Gutman, Herzelia (IL)

(21) Appl. No.: 15/973,375

(22) Filed: May 7, 2018

(51) Int. Cl. G06Q 10/06; G06N 99/00

(52) U.S. Cl. CPC G06Q 10/06313; G06N 99/005; G06Q 10/063112

(57) ABSTRACT

The disclosure provides for associating users with roles in projects. Implementations include determining entity features of project entities. The project entities are grouped into projects based on similarities of the entity features between the project entities. From content of the project entities of a project of the projects, occurrences of events with respect to users are determined, where each event corresponds to one or more predefined user activities. The occurrences of the events are analyzed to determine, for each user of a plurality of the users, an engagement level of the user with the project. A role for the project is assigned to the user from predefined roles based on applying a role feature corresponding to the engagement level of the user to a machine learning model that represents the role, and an assignment of the user to the role is incorporated into a project repository.

### BACKGROUND

Users of computer devices are often involved in many different projects, whether they be personal projects or work projects. Any number of project entities may be used to facilitate a particular project including emails, files, contacts, projects, and the like. Project management technologies typically structure projects and capture information related to projects using approaches that significantly impair a computing system's ability to leverage project data for project-related applications. For example, a typical approach to project management software relies on manual human configuration, such as by requiring users to group files into projects, which could include arranging emails into folders by project. This results in many types of information relevant to projects not being captured or being captured in an unreliable form that lacks context. For example, this information may not reflect behavior of users with respect to projects, such as a user leading discussion of a particular aspect of a project in a meeting, a user assigning tasks to other users for the project, a user providing feedback on project content, and the like. Thus, a computing system is unable to leverage this information in a reliable way for project-related applications.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Embodiments of the present disclosure relate to computer project management technologies for structuring and capturing various user behavior with respect to projects to improve the ability of a computing system to implement project-related applications and services. This may be accomplished using a nuanced modeling of projects and user interactions with respect to those projects that captures information that is typically unavailable and structures that information in a flexible and adaptable manner so that it can be leveraged by a computing system.

In some aspects, a computing system may automatically identify and maintain projects by grouping entities, such as emails, files, contacts, meetings, and appointments, based on similarities between content of those entities, metadata of those entities, and/or detected user interactions, or events, with respect to those entities. Approaches described herein may determine occurrences of events with respect users, where an event corresponds to one or more predefined user activities, such as a user leading discussion of a particular aspect of a project in a meeting, a user assigning tasks to other users for the project, a user providing feedback on project content, and the like.

In some embodiments, various predefined roles are established for a project, where each role is structured as a machine learning model that uses role features to determine whether a particular user has that role, and/or a confidence level or score that the user has the role. The machine learning model may be implemented as an inference engine and the role features and/or weighting of the role features may be machine learned and/or predefined. For example, in some embodiments, roles are machine learned by grouping (e.g., using a clustering algorithm) different events and other contextual information related to projects into roles. One or more events and other contextual information in a group can define role features for a machine learning model that represents a role that corresponds to the group. A user may be assigned the role based on evaluating similarities between the group of events and other contextual information and occurrences of events in association with the user and other user contextual information. In some embodiments, weightings for role features of the machine learning model may optionally be determined by extracting patterns from values associated with the events and other contextual information such that a weight corresponds to a strength of an extracted pattern.

In some embodiments, a role feature corresponds to or is based on an engagement level of a user with a project. The engagement level may be determined by analyzing occurrences of events with respect to a user and may be based on a frequency of occurrences of events for the user with respect to a project. In addition, or alternatively, a role feature may be based on project state categories (e.g., a category that represents a state or phase of the project, such as a decision point, a milestone, a status meeting) assigned to the occurrences of the events. As a further example, a role feature may be based on content subject matter categories (e.g., a category that represents a subject matter topic of content) assigned to the occurrences of the events.

Any of the various project-related information may be stored in a project repository and used to determine content related to a project. For example, role associations to users and/or engagement levels of users may be used to schedule or reschedule project meetings based on the appropriate users for the meeting, to rank project entities for particular users, such as for display to the user, and/or to determine whether to notify or alert particular users, such as when new content is available for the project or when project content is changed or modified. In various cases, the project-related information may allow a computing system to effectively target project-related applications and services to particular users, rather than all users associated with a project, thereby reducing computing resources for content delivery and enhancing the security of project-related content.

### BRIEF DESCRIPTION OF THE DRAWINGS

The present invention is described in detail below with reference to the attached drawing figures, wherein:

FIG. 1 is a block diagram of an example computing environment suitable for use in implementing embodiments of the present invention;

FIG. 2A is a block diagram illustrating an example project management system in which some embodiments of the present invention may be employed;

FIG. 2B is a block diagram illustrating an example project management system in which some embodiments of the present invention may be employed;

FIG. 3 is a flow diagram that illustrates a method for associating meetings with projects in accordance with embodiments of the present disclosure;

FIG. 4 is a flow diagram that illustrates a method for associating meetings with projects in accordance with embodiments of the present disclosure;

FIG. 5 is a flow diagram that illustrates a method for associating meetings with projects in accordance with embodiments of the present disclosure; and

FIG. 6 is a block diagram that illustrates an example computing device in accordance with embodiments of the present disclosure.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Each method described herein may comprise a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a stand-alone application, a service or hosted service (stand-alone or in combination with another hosted service), or a plug-in to another product, to name a few.

Embodiments of the present disclosure relate to computer project management technologies for structuring and capturing various user behavior with respect to projects to improve the ability of a computing system to implement project-related applications and services. This may be accomplished using a nuanced modeling of projects and user interactions with respect to those projects that captures information that is typically unavailable and structures that information in a flexible and adaptable manner so that it can be leveraged by a computing system.

In some aspects, a computing system may automatically identify and maintain projects by grouping entities, such as emails, files, contacts, meetings, and appointments, based on similarities between content of those entities, metadata of those entities, and/or detected user interactions, or events, with respect to those entities. Approaches described herein may determine occurrences of events with respect to users, where an event corresponds to one or more predefined user activities, such as a user leading discussion of a particular aspect of a project in a meeting, a user assigning tasks to other users for the project, a user providing feedback on project content, and the like.

In some embodiments, various predefined roles are established for a project, where each role is structured as a machine learning model that uses role features to determine whether a particular user has that role, and/or a confidence level that the user has the role. The machine learning model may be implemented as an inference engine and the role features and/or weighting of the role features may be machine learned and/or predefined. For example, in some embodiments, roles are machine learned by grouping (e.g., using a clustering algorithm) different events and other contextual information related to projects into roles. One or more events and other contextual information in a group can define role features for a machine learning model that represents a role that corresponds to the group. A user may be assigned the role based on evaluating similarities between the group of events and other contextual information and occurrences of events in association with the user and other user contextual information. In some embodiments, weightings for role features of the machine learning model may optionally be determined by extracting patterns from values associated with the events and other contextual information such that a weight corresponds to a strength of an extracted pattern.

In some embodiments, a role feature corresponds to or is based on an engagement level of a user with a project. The engagement level may be determined by analyzing occurrences of events with respect to a user and may be based on a frequency of occurrences of events for the user with respect to a project. In addition, or alternatively, a role feature may be based on project state categories (e.g., a category that represents a state of the project, such as a decision point, a milestone, a status meeting) assigned to the occurrences of the events. As a further example, a role feature may be based on content subject matter categories (e.g., a category that represents a subject matter topic of content) assigned to the occurrences of the events.

Any of the various project-related information may be stored in a project repository and used to determining content related to a project. For example, role associations to users and/or engagement levels of users may be used to schedule or reschedule project meetings based on the appropriate users for the meeting, to rank project entities for particular users, such as for display to the user, and/or to determine whether to notify or alert particular users, such as when new content is available for the project or when project content is changed or modified. In various cases, the project-related information may allow a computing system to effectively target project-related applications and services to particular users, rather than all users associated with a project, thereby reducing computing resources for content delivery and enhancing the security of project-related content.

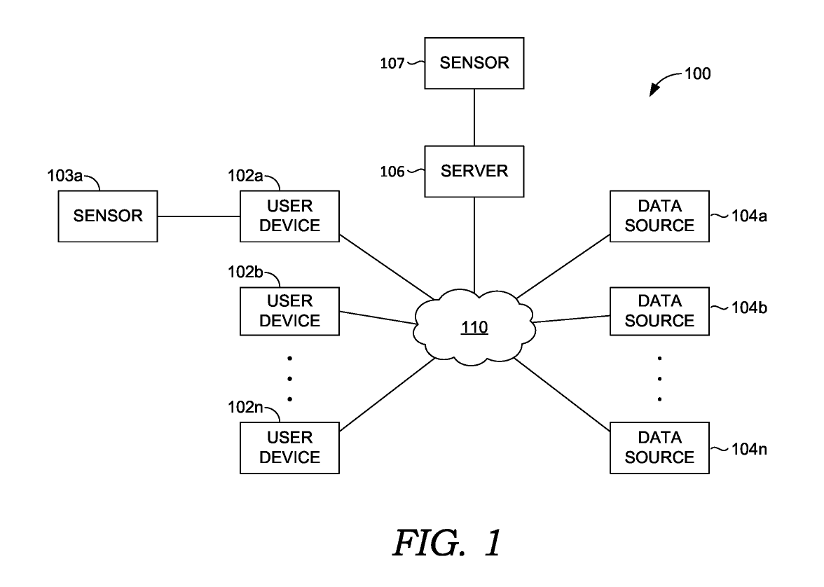

Turning now to FIG. 1, a block diagram is provided showing an example operating environment 100 in which some embodiments of the present disclosure may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

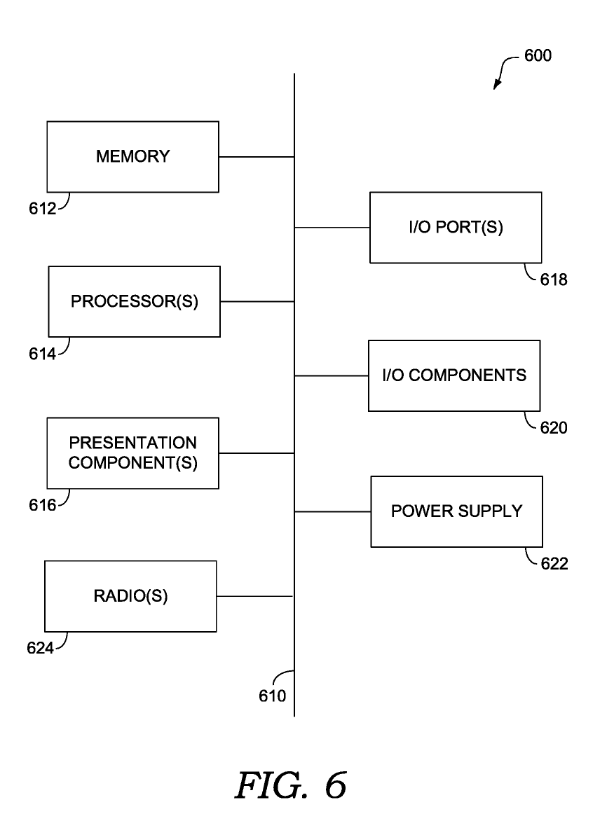

Among other components not shown, example operating environment 100 includes a number of user devices, such as user devices 102a and 102b through 102n; a number of data sources, such as data sources 104a and 104b through 104n; server 106; sensors 103a and 107; and network 110. It should be understood that operating environment 100 shown in FIG. 1 is an example of one suitable operating environment. Each of the components shown in FIG. 1 may be implemented via any type of computing device, such as computing device 600, described in connection to FIG. 6, for example. These components may communicate with each other via network 110, which may include, without limitation, one or more local area networks (LANs) and/or wide area networks (WANs). In example implementations, network 110 comprises the Internet and/or a cellular network, amongst any of a variety of possible public and/or private networks.

It should be understood that any number of user devices, servers, and data sources may be employed within operating environment 100 within the scope of the present disclosure. Each may comprise a single device or multiple devices cooperating in a distributed environment. For instance, server 106 may be provided via multiple devices arranged in a distributed environment that collectively provide the functionality described herein. Additionally, other components not shown may also be included within the distributed environment.

User devices 102a and 102b through 102n may comprise any type of computing device capable of use by a user. For example, in one embodiment, user devices 102a through 102n may be the type of computing device described in relation to FIG. 6 herein. By way of example and not limitation, a user device may be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, a camera, remote control, a bar code scanner, a computerized measuring device, appliance, consumer electronic device, a workstation, or any combination of these delineated devices, or any other suitable device.

User devices 102a and 102b through 102n can be client devices on the client-side of operating environment 100, while server 106 can be on the server-side of operating environment 100. Server 106 can comprise server-side software designed to work in conjunction with client-side software on user devices 102a and 102b through 102n so as to implement any combination of the features and functionalities discussed in the present disclosure. This division of operating environment 100 is provided to illustrate one example of a suitable environment, and there is no requirement for each implementation that any combination of server 106 and user devices 102a and 102b through 102n remain as separate entities.

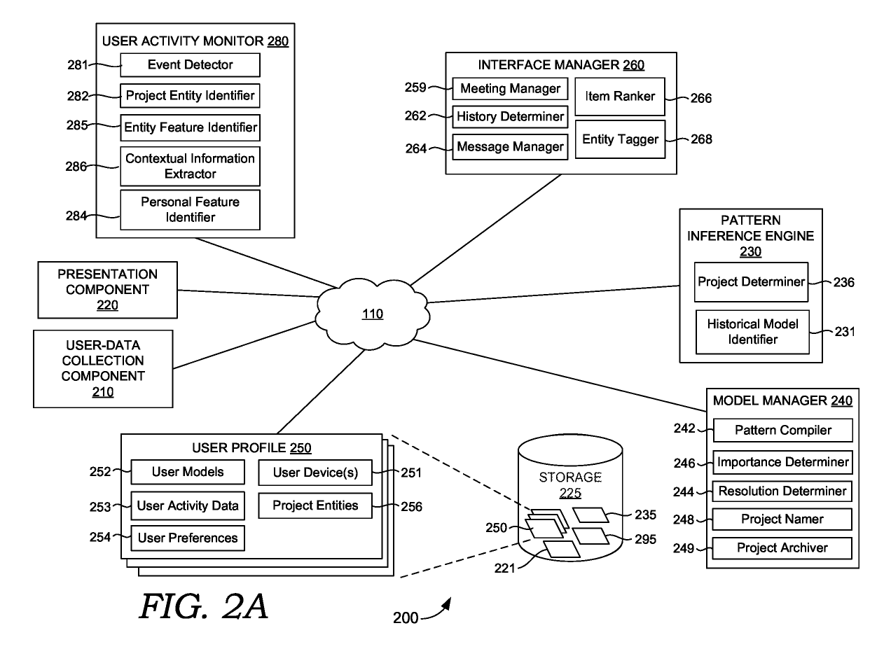

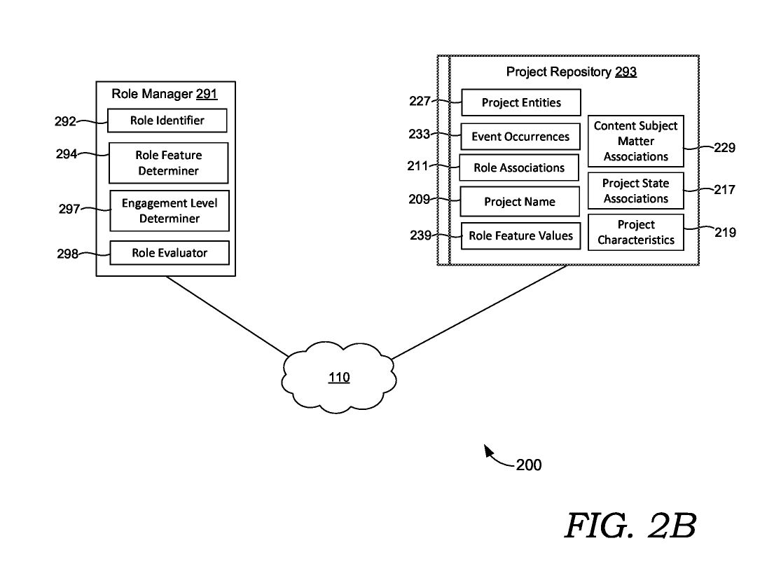

Data sources 104a and 104b through 104n may comprise data sources and/or data systems, which are configured to make data available to any of the various constituents of operating environment 100, or project management system 200 described in connection to FIG. 2A. For instance, in one embodiment, one or more data sources 104a through 104n provide (or make available for accessing) data to user-data collection component 210 of FIG. 2A. Data sources 104a and 104b through 104n may be discrete from user devices 102a and 102b through 102n and server 106 or may be incorporated and/or integrated into at least one of those components. In one embodiment, one or more of data sources 104a through 104n comprises one or more sensors, which may be integrated into or associated with one or more of the user device(s) 102a, 102b, or 102n or server 106. Examples of sensed project data made available by data sources 104a through 104n are described further in connection to user-data collection component 210 of FIG. 2A.

Operating environment 100 can be utilized to implement one or more of the components of project management system 200, described in FIG. 2A, including components for collecting user data, inferring project and meeting patterns, generating project and meeting models, generating event details or features, identifying meetings, associating meetings with projects and project entities, and/or presenting project and/or meeting related content to users.

Example of a Project Management System

FIG. 2A and FIG. 2B provide block diagrams illustrating an example project management system 200 in which some embodiments of the present disclosure may be employed. In particular, project management system 200 is one example of a system capable of determining projects from user data, identifying and extracting project roles from user data, and associating the project roles with projects and/or users.

Project management system 200 includes network 110, which is described in connection to FIG. 1, and which communicatively couples components of project management system 200, including user-data collection component 210, presentation component 220, storage 225, pattern inference engine 230, model manager 240, user profile(s) 250, interface manager 260, user activity monitor 280, role manager 291, and project repository 293. The components of project management system 200 may be embodied as a set of compiled computer instructions or functions, program modules, computer software services, or an arrangement of processes carried out on one or more computer systems, such as computing device 600 described in connection to FIG. 6, for example.

In one embodiment, the functions performed by components of project management system 200 are associated with one or more personal assistant applications, services, or routines. In particular, such applications, services, or routines may operate on one or more user devices (such as user device 102a), servers (such as server 106), may be distributed across one or more user devices and servers, or be implemented in the cloud. Moreover, in some embodiments, these components of project management system 200 may be distributed across a network, including one or more servers (such as server 106) and client devices (such as user device 102a), in the cloud, or may reside on a user device such as user device 102a. Moreover, these components, functions performed by these components, or services carried out by these components may be implemented at appropriate abstraction layer(s), such as the operating system layer, application layer, hardware layer, etc., of the computing system(s).

Alternatively, or in addition, the functionality of these components and/or the embodiments of the invention described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 200, it is contemplated that in some embodiments functionality of these components can be shared or distributed across other components.

As noted above, it should be understood that project management system 200 shown in FIG. 2A and FIG. 2B is an example of one system in which embodiments of the present invention may be employed. Each component shown may include one or more computing devices similar to the operating environment 100 described with reference to FIG. 1. Project management system 200 should not be interpreted as having any dependency or requirement related to any single module/component or combination of modules/components illustrated therein. Each may comprise a single device or multiple devices cooperating in a distributed environment. For instance, project management system 200 may comprise multiple devices arranged in a distributed environment that collectively provide any of the various functionalities described herein. Additionally, other components not shown may also be included within the environment. It should therefore be understood that project management system 200 and/or its various components may be embodied by any suitable computer arrangement in accordance with various embodiments of the present disclosure.

Project management system 200 generally operates to manage projects with respect to project entities. As used herein, a “project entity” refers to a data object that system 200 associates with one or more projects. Examples include files, documents, emails, events, calendar events, meetings, contacts, users, word processing documents, meeting participants, image documents, presentation documents, applications, time slots, text such as words or phrases, topics, search queries or history, concepts, keywords, pictures, locations, venues, roles, and more.

This can include identifying meetings from user activity data, determining project entities associated with meetings, tracking meetings, and correlating meetings with projects. In some respects, a meeting can be identified using project characteristics, formed by patterns extracted from project data, and determined from project models. These project characteristics can include project keywords, which when detected in a conversation indicate the conversation corresponds to a meeting that may be related to a project. In further respects, correlating a meeting with a project can be based on the similarity between project characteristics and meeting context, identified from user data in association with a particular meeting. For example, this can include determining how similar a set of project keywords associated with the project are to a set of meeting keywords associated with the meeting. Where the similarity is sufficiently high, the meeting may be assigned to the project, as well as any project entities associated with the meeting. The project characteristics and meeting context can thereby act as a bridge between meetings and projects.

As briefly mentioned above, each component of project management system 200, including user-data collection component 210, presentation component 220, pattern inference engine 230, model manager 240, user profile 250, interface manager 260, user activity monitor 280, role manager 291, and project repository 293 and their respective subcomponents, may reside on a computing device (or devices). For example, the components of project management system 200 may reside on the example computing device 600 described below and shown in FIG. 6, or similar devices. Accordingly, each component of the project management system 200 may be implemented using one or more of a memory, a processor or processors, presentation components, input/output (I/O) ports and/or components, radio(s), and a power supply (e.g., as represented by reference numerals 612-624, respectively, in FIG. 6).

As an overview, in some embodiments, user-data collection component 210 facilitates the intake of data and makes the data available to project management system 200 in association with users (i.e., user data). User activity monitor 280 analyzes the user data to identify project entities, such as meetings, extract contextual features associated with user data, and extract personal features of users, such as characteristic features of users. Additionally, system 200 may associate a project entity with other project entities. For example, a meeting may be associated with any of various files, documents, events, and contacts that were included in a corresponding scheduled meeting, such as in a meeting request, and/or accessed, discussed, or referenced during or by the meeting.

Pattern inference engine 230 uses any combination of the various data provided by user activity monitor 280 to apply semantic understanding to project entities; identify previous projects for project entities, when available; identify project entities, such as meetings, from user data; and determine patterns formed by user data for projects and/or roles.

Model manager 240 uses the various pattern information from pattern inference engine 230 to create and/or update project, meeting, and/or role models, determine the importance of individual projects, meetings, and/or roles, determine characteristics of projects, meetings, and/or roles (e.g., context that characterizes those items), determine which role features to use for particular role models, determine weightings for role features of roles, determine values of role features for particular users, determine the resolution or granularity of projects, name projects, archive projects, identify meetings, correlate meetings and roles with projects, track meetings, and determine meeting context (e.g., keywords).

Interface manager 260 facilitates the application of project models, meeting models, and role models, including information derived therefrom, to computer applications, computer services, computer routines, and the like. This may be performed in conjunction with presentation component 220.

User-data collection component 210 is generally responsible for accessing or receiving (and in some cases also identifying) project data and meeting data from one or more data sources, such as data sources 104a and 104b through 104n of FIG. 1. In some embodiments, user-data collection component 210 may be employed to facilitate the accumulation of user data of a particular user (or in some cases, a plurality of users including crowdsourced data) for user activity monitor 280 and pattern inference engine 230.

The data may be received (or accessed), and optionally accumulated, reformatted, and/or combined, by user-data collection component 210 and stored in one or more data stores, such as storage 225, where it may be made available to other components of project management system 200. For example, the user data may be stored in or associated with user profile 250, as described herein. In various embodiments, any personally identifying data (i.e., user data that specifically identifies particular users) is either not uploaded from the one or more data sources with user data, is not permanently stored, and/or is not made available to user activity monitor 280 and pattern inference engine 230. Further, it is contemplated that any features related to user-data collection and retention be optional and at the discretion of individual users.

User data, which may include project data and meeting data, may be received from a variety of sources where the data may be available in a variety of formats. For example, in some embodiments, user data received via user-data collection component 210 may be determined via one or more sensors (such as sensors 103a and 107 of FIG. 1), which may be on or associated with one or more user devices (such as user device 102a), servers (such as server 106), and/or other computing devices. As used herein, a sensor may include a function, routine, component, or combination thereof for sensing, detecting, or otherwise obtaining information, such as user data from a data source 104a, and may be embodied as hardware, software, or both.

By way of example and not limitation, user data may include data that is sensed or determined from one or more sensors (referred to herein as sensor data), such as location information of mobile device(s), smartphone data (such as phone state, charging data, date/time, or other information derived from a smartphone), user-activity information (for example: app usage; online activity; searches; voice data such as automatic speech recognition; activity logs; communications data including calls, texts, instant messages, and emails; website posts; other user data associated with communication events; etc.) including user activity that occurs over more than one user device, user history, session logs, application data, contacts data, calendar and schedule data, notification data, social network data, news (including popular or trending items on search engines or social networks), online gaming data, ecommerce activity (including data from online accounts such as Microsoft®, Amazon.com®, Google®, eBay®, PayPal®, video-streaming services, gaming services, or Xbox Live®), user-account(s) data (which may include data from user preferences or settings associated with a personalization-related (e.g., “personal assistant”) application or service), home-sensor data, data from a discrete or physical sensor, appliance data, global positioning system (GPS) data, vehicle signal data, traffic data, weather data (including forecasts), wearable device data, other user device data (which may include device settings, profiles, network connections such as Wi-Fi® network data, or configuration data, data regarding the model number, firmware, or equipment, device pairings such as where a user has a mobile phone paired with a Bluetooth headset, for example), gyroscope data, accelerometer data, payment or credit card usage data (which may include information from a user's PayPal® account), purchase history data (such as information from a user's Amazon.com® or eBay® account), other sensor data that may be sensed or otherwise detected by a sensor (or other detector) component including data derived from a sensor component associated with the user (including location, motion, orientation, position, user-access, user-activity, network-access, user-device-charging, or other data that is capable of being provided by one or more sensor components), data derived based on other data (for example, location data that can be derived from Wi-Fi®, cellular network, or IP address data), and nearly any other source of data that may be sensed or determined as described herein.

In some embodiments, user data may be provided in at least one user-data stream or “user signal,” which can be a feed or stream of user data from a data source. For instance, a user signal could be from a smartphone, a home-sensor device, a GPS device (e.g., for location coordinates), a vehicle-sensor device, a wearable device, a user device, a gyroscope sensor, an accelerometer sensor, a calendar service, an email account, a credit card account, or other data sources. In some embodiments, user-data collection component 210 receives or accesses the data continuously, periodically, or as needed.

User data, particularly in the form of event data and/or location data can be received by user-data collection component 210 from one or more sensors and/or computing devices associated with a user. While it is contemplated that the user data is processed, by the sensors or other components not shown, for interpretability by user-data collection component 210, embodiments described herein do not limit the user data to processed data and may include raw data.

User activity monitor 280 is generally responsible for monitoring user data or information that may be used for identifying and/or managing projects, roles, and meetings on behalf of one or more users. User activity monitor 280 can employ role manager 291, event detector 281, contextual information extractor 286, project entity identifier 282, entity feature identifier 285, and personal feature identifier 284 to use this information to identify, determine, generate, collect, and/or maintain project entities, contextual features, and/or personal features that correspond to user activity associated with one or more users. Any combination of this data may be stored by user activity monitor 280 as user account(s)/activity data in association with users, such as user activity data 253. These include features (sometimes referred to herein as “variables,” such as project, role, or meeting features or variables) or other information relating to projects, roles, and meetings that are identified and/or tracked by user activity monitor 280 with respect to one or more users.

As an overview, event detector 281 detects events, such as events that may be associated with projects or project entities, such as meetings, from user activity. Project entity identifier 282 identifies project entities, such as meetings, based on events detected by event detector 281 or otherwise based on identifying entities associated with users (i.e., using non-event based identification). Entity feature identifier 285 determines features of project entities, such as contextual features of particular project entities, and personal feature identifier 284 identifies personal features of users. Any of these various components can employ contextual information extracted by contextual information extractor 286 from user data, project or meeting entities, and/or detected events.

Embodiments of user activity monitor 280 may determine, from the monitored user data, user activity associated with a particular user. As described previously, the user activity information determined by user activity monitor 280 may include user activity information from multiple user devices associated with the user and/or from cloud-based services associated with the user (such as email, calendars, social media, or similar information sources). User activity monitor 280 may determine current or near-real-time user activity information and may also determine historical user activity information, in some embodiments, which may be determined based on gathering observations of user activity over time and/or accessing user logs of past activity (such as browsing history, for example), which may be stored in user activity data 253 in user profile 250. Further, in some embodiments, user activity monitor 280 may determine user activity (which may include historical activity) from other similar users (i.e., crowdsourcing), as described previously. For example, user data from other users collocated with the user during an event may be analyzed to determine entity features.

In some embodiments, information determined by user activity monitor 280 may be provided to pattern inference engine 230 including information regarding project entities (e.g., meetings), context features of those project entities, and historical features (historical observations, which may be provided from records in user profile 250).

As indicated above, in some embodiments, the user data and/or information about user activity determined from user activity monitor 280, including project-event related information, is stored in a user profile, such as user profile 250. This can include project entities 256 identified by project entity identifier 282 and/or user activity data 253 extracted by entity feature identifier 285, personal feature identifier 284, event detector 281, and/or contextual information extractor 286.

In an embodiment, user activity monitor 280 comprises one or more applications or services that analyze information detected via one or more user devices used by the user and/or cloud-based services associated with the user, to determine project-related activity information and related contextual information. Information about user devices associated with a user may be determined from the user data made available via user-data collection component 210, and may be provided to user activity monitor 280, pattern inference engine 230, or other components of project management system 200. More specifically, in some implementations of user activity monitor 280, a user device may be identified by detecting and analyzing characteristics of the user device, such as device hardware, software such as operating systems (OSs), network-related characteristics, user accounts accessed via the device, and similar characteristics. For example, information about a user device may be determined using functionality of many operating systems to provide information about the hardware, OS version, network connection information, installed application, or the like.

User activity monitor 280 may, at least partially, operate to detect user profile activity that is related to events associated with one or more users. Some embodiments of user activity monitor 280, or its subcomponents, may determine a device name or identification (device ID) for each device associated with a user profile. This information about the identified user devices associated with a user profile may be stored in a user profile associated with the user, such as in user device(s) 251 of user profile 250. In an embodiment, the user devices may be polled, interrogated, or otherwise analyzed to determine information about the devices. This information may be used for determining a label or identification of the device (e.g., a device ID) so that the user profile interaction with the device may be recognized from user profile data by user activity monitor 280. In some embodiments, user profiles may declare or register a device, such as by logging into an account via the device, installing an application on the device, connecting to an online service that interrogates the device, or otherwise providing information about the device to an application or service. In some embodiments, devices that sign into an account associated with the user profile, such as a Microsoft® account or Net Passport, email account, social network, or the like, are identified and determined to be associated with the user profile. Information in one or more of these accounts may provide project entities or user data that user activity monitor 280 may use to infer project entities, such as meetings.

In some embodiments, user activity monitor 280, one or more of its subcomponents, or other components of project management system 200, such as model manager 240 or pattern inference engine 230, may determine interpretive data from received user data. Interpretive data corresponds to data utilized by the components of project management system 200 or subcomponents of user activity monitor 280 to interpret user data. For example, interpretive data can be used to provide other context to raw user data, which can support determinations or inferences made by the components or subcomponents (e.g., to infer user activity, events, roles, contextual or personal features, and the like). Moreover, it is contemplated that embodiments of user activity monitor 280, its subcomponents, and other components of project management system 200 may use user data and/or user data in combination with interpretive data for carrying out the objectives of the subcomponents described herein. Additionally, although several examples of how user activity monitor 280 and its subcomponents may identify user profile activity information are described herein, many variations of user profile activity identification and user profile activity monitoring are possible in various embodiments of the disclosure.

Contextual information extractor 286, in general, is responsible for determining contextual information related to the user profile activity (detected by user activity monitor 280), such as context, features or variables associated with project entities and/or events (e.g., detected keywords), related information, other user-related activity, and is further responsible for associating the determined contextual information with the related events and/or project entities. In some embodiments, contextual information extractor 286 may associate the determined contextual information with a related event or entity and may also log the contextual information with the associated event or entity. Alternatively, the association or logging may be carried out by another service. For example, some embodiments of contextual information extractor 286 provide the determined contextual information to entity feature identifier 285, which determines entity features for entities, and personal feature identifier 284, which determines user personal features for the user profile.

Some embodiments of contextual information extractor 286 determine contextual information in relation to project entities (e.g., people or contacts present during a meeting and/or event or invited to a meeting and/or event, such as recipients of a group email, invite, or scheduled meeting, related to the meeting or event) or the location or venue wherein the meeting or event took place, is taking place, or will take place. By way of example and not limitation, this may include context features such as location data, which may be represented as a location stamp associated with an event; contextual information about the location, such as venue information (e.g., this is the user's office location, home location, conference room, library, school, restaurant, move theater), time, day, and/or date, which may be represented as a time stamp associated with the event and which, in some embodiments, may include yellow pages identifier (YPID) information; duration of the event, which may be different than a scheduled duration (i.e., the project was longer or shorter than scheduled); other user projects or activities preceding and/or following the event; other information about the event such as project entities associated with the event (e.g., venues, participants, contacts, people, objects, which may be invited, in attendance, involved in planning, or otherwise involved); information detected by sensor(s) on user devices associated with the user that is concurrent or substantially concurrent to the event (e.g., location, motion information, online activity, user-device interactions, or physiological information detected on a fitness tracking user device); or any other information related to the event that is detectable that may be used for determining patterns of user-related activity associated with projects and meetings related to the user.

In embodiments using contextual information related to user devices, a user device may be identified by detecting and analyzing characteristics of the user device, such as device hardware, software such as operating system (OS), network-related characteristics, user accounts accessed via the device (e.g., online calendars), and similar characteristics. For example, as described previously, information about a user device may be determined using functionality of many operating systems to provide information about the hardware, OS version, network connection information, installed application, or the like. In some embodiments, a device name or identification (device ID) may be determined for each device associated with a user profile. This information about the identified user devices associated with a user profile may be stored in a user profile associated with the user, such as in user device(s) 251 of user profile 250.

In an embodiment, the user devices may be polled, interrogated, or otherwise analyzed to determine contextual information about the devices. In some implementations, contextual information extractor 286 may receive user data from user-data collection component 210, parse the data, in some instances, and identify and extract context features or variables (which may also be carried out by entity feature identifier 285 and personal feature identifier 284). Context variables may be stored as a related set of contextual information associated with an event (e.g., a meeting event) and/or project entity, and may be stored in a user profile, such as in user activity data 253.

Event detector 281, in general, is responsible for determining (or identifying) that an event has occurred. As used herein, an “event” corresponds to one or more predefined user activities detectable via one or more computing devices. For example, an event may correspond to a user providing opening remarks for a meeting, and the event may be said to have occurred each time it is determined that the user has provided opening remarks for the meeting. While details of the remarks (e.g., contextual features) may vary from occurrence to occurrence, each occurrence captures common predefined user activity. As will later be described in additional detail, embodiments of event detector 281 may be used by project entity identifier 282 to generate or identify project entities, by entity feature identifier 285 to extract contextual features of entities, and/or by personal feature identifier 284 to generate or identify personal features of the user.

Some embodiments of event detector 281 may monitor user data for project-related or role features or variables corresponding to user activity, such as communications received (e.g., project requests or calendar-related communications), indications of applications launched or accessed, files accessed, modified, copied, etc., websites navigated to, online content downloaded and rendered or played, user location or change of location (e.g., user is located in or has changed locations to a conference room), or similar user activities.

Additionally, some embodiments of event detector 281 use contextual information extractor 286 to extract from the user data information about events, which may include current activity, historical activity, and/or related information such as contextual information. Alternatively or in addition, in some embodiments, event detector 281 uses contextual information extractor 286 to determine and extract contextual information that is related to one or more project entities.

Examples of project-related activity information, such as meeting-related activity information, that can be extracted by contextual information extractor 286 and used by components of user activity monitor 280, such as event detector 281, referred to herein as project features, may include information describing app usage, online activity, searches, calls, usage duration, application data (e.g., project requests, emails, messages, posts, user profile status, notifications), or nearly any other data related to a user that is detectable via one or more user devices or computing devices, including user interactions with the user device, activity related to cloud services associated with the user (e.g., calendar or scheduling services), online account activity (e.g., email and social networks), and social network activity. As will be appreciated, project features can include meeting features where such information is associated with a meeting or an event that may be associated with a meeting (i.e., a meeting event).

Among other components of project management system 200, the extracted event information determined by event detector 281 may be provided to other subcomponents of user activity monitor 280 (e.g., entity feature identifier 285 and personal feature identifier 286), pattern inference engine 230, interface manager 260, or other components of project management system 200. Further, the extracted event information may be stored in a user profile associated with the user, such as in user activity data 253 of user profile 250. In some embodiments, event detector 281 or user activity monitor 280 (or its other subcomponents) performs conflation on the detected project-related information. For example, overlapping information may be merged and duplicated or redundant information eliminated.

In some embodiments, the user data may be interpreted to determine that an event has occurred. For example, in some embodiments, event detector 281 employs event logic 295, which may include rules, conditions, associations, classification models, or other criteria to identify project-related activity, such as meeting-related activity. For example, in one embodiment, event logic 295 may include comparing event criteria with the user data in order to determine that an event has occurred.

In some embodiments, the identification and/or classification of events can be based on feature-matching or determining similarity in features, which may be carried out using statistical classification processes Thus, event logic 295 may comprise pattern recognition classifier(s), fuzzy logic, neural network, finite state machine, support vector machine, logistic regression, clustering, or machine-learning techniques, similar statistical classification processes, or combinations of these to identify events from user data. Accordingly, event logic 295 can take many different forms depending on the mechanism used to identify an event, and may be stored in storage 225. For example, event logic 295 might include training data used to train a neural network that is used to evaluate user data to determine when an event has occurred. Moreover, event logic 295 may specify types of project features or user activity, such as specific user device interaction(s), that are associated with an event, accessing a schedule or calendar, accessing materials associated with a project entity (e.g., an agenda or presentation materials in a meeting), composing or responding to a project request communication, acknowledging a notification, navigating to a website, or launching an app. In some embodiments, a series or sequence of user-related activity may be mapped to an event, such that the event may be detected upon determining that the user data indicates the series or sequence of user-related activity has occurred or been carried out by the user. In some embodiments, one or more models of roles, described in more detail below, may use event logic 295.

In some embodiments, event detector 281 runs on or in association with each user device for a user. Event detector 281 may include functionality that polls or analyzes aspects of the user device, which may include online- or cloud-services accessible via the user device, to determine project-related features, such as sensor output, applications running (and in some instances the content of the applications), network communications, online/cloud activity related to the user, and/or other user actions detectable via the user device including sequences of actions.

Project entity identifier 282 is generally operable to identify any of the various project entities described herein with respect to one or more users. These identified project entities may be stored in association with one or more users, such as in project entities 256 of user profile 250. Project entity identifier 282 may identify project entities using any suitable means. In some cases, project entity identifier 282 identifies one or more project entities as an event, such as an event detected by event detector 281. As one example, the event could be a meeting event, an event capturing the user working on a project (e.g., using an application), and more. To this effect, an event may be an inferred project entity, where the system generates the project entity based on inferences derived from user data.

In some cases, project entity identifier 282 identifies an event as a project entity based on determining the event occurred, which may be based on a confidence score or other metric evaluating whether the event occurred. In other cases, project entities can be explicit project entities, which are explicit in user data. Examples of explicit project entities include files, emails, calendar items such as meetings, contact entries, and the like. One or more of these project entities may correspond to a data object having content explicitly defined or definable by one or more users (e.g., the message body of an email, start and end times of a meeting).

In some cases, project entity identifier 282 may identify one or more project entities based on one or more events detected by event detector 281. For example, project entity identifier 282 can identify project entities from contextual information or features associated with one or more events. For example, contextual information associated with a meeting event may comprise variables defining extractable project entities such as emails accessed during the meeting, location of the meeting or of the user during the meeting, photos taken during a meeting, users or contacts attending or invited to the meeting, files accessed or created during the meeting, search queries provided during the meeting such as file searches performed during the meeting or web searches performed during the meeting, and the like.

It is noted that project entity identifier 282 need not identify project entities in association with events. For example, project entity identifier 282 could identify and extract project entities (e.g., explicit project entities) directly from user data. This extraction could be defined by any number of extraction rules, which may define data object types (e.g., calendar items, emails, attachments, scheduled meetings), locations, associated applications, and the like for project entities. In some implementations, any combination of this information is captured by metadata or content of a data object, and project entity identifier 282 analyzes the metadata or content to determine whether to identify the data object as a project entity.

In various implementations, project entity identifier 282 identifies project entities in association with one or more email applications, such as based on being generated or accessed by an email application or in association with an email application, based on being referenced by or to an email application, and/or based on being used by or in association with an email application. For example, project entity identifier 282 can identify emails and/or meeting invites that are sent or received using the enterprise application, attachments to emails or meetings, as well as meetings themselves as project entities. Contextual information extractor 286 can extract meeting context for a meeting project entity from the various metadata of a meeting invite, such as attachments, titles, subject lines, locations, confirmed participants, invited participants, and the like (which may include project entities) associated with the meeting. Other project entities include contacts from the email application and/or from a global contacts list associated with users, which may include a contacts list tracked across user devices and/or integrated into operating system software.

Events can be project entities generated by project management system 200. As another example, project entity identifier 282 can generate a time slot as a project entity for projects of users. As used herein, a “time slot” can refer to a data object representing a period of time in which one or more activities can be performed by one or more users on one or more computing devices for one or more projects. In some cases, project entity identifier 282 is configured to generate time slots such that the set of time slots used by system 200 are non-overlapping.

In some implementations, one or more of the time slots are generated from calendar and/or meeting data associated with one or more users. For example, the time slots could be extracted from the email application described above, or a more global calendaring and scheduling service. A time slot could be defined by a start time and an end time for a meeting (e.g., extracted from scheduled meetings and/or meeting invites or requests), as one example. However, project entity identifier 282 could otherwise base generation of a time slot on a meeting, such as by defining a start time of a time slot as an arrival time of a user to a meeting and/or an end time of the time slot as a departure time of the user from the meeting.

It should be appreciated that the meeting may optionally correspond to an event and/or calendar item associated with the user. Features of the project entity, such as start time and end time can be identified and/or assigned by entity feature identifier 285, which is further described below.

Thus, in some embodiments, project entity identifier 282 generates one or more of the time slots by detecting one or more events corresponding to user activity on one or more computing devices in association with a period of time. The period of time used for a time slot could correspond to the period of time over which the user activity occurred, as an example. As another example, the user activity could be inferred and the time slot could be determined based on analyzing patterns formed by previous time-stamped events corresponding to the user activity. In some cases, the period of time is determined based on entity features of one or more project entities, or otherwise extracted in association with a project entity. As an example, the period of time could be determined based on analyzing content and/or metadata of a data object corresponding to a project entity. This could include data object edit data (e.g., last date edited, accessed, date created). Another example includes email sending or receiving data (e.g., time sent, time received, and the like). In various implementations, the period of time could be determined from one or more time stamps associated with or assigned to events and/or project entities.

Other examples of project entities that can be generated by project management system 200 include text entities, topic entities, concept entities, and keyword entities. As used herein, a text entity can refer to a project entity that represents text, such as words, phrases, and the like. In some implementations, one or more of these project entities are generated by pattern inference engine 230, and therefore, these forms of entities are later described in further detail with respect to pattern inference engine 230.

Entity feature identifier 285 is generally responsible for identifying and optionally determining entity or project features (or variables) associated with the entities that may be used for identifying patterns corresponding to user projects. As indicated above, entity features may be determined from information about an event and/or from related contextual information associated with the project entity. In some embodiments, entity feature identifier 285 receives user-project or related information (e.g., contextual information) from user activity monitor 280 (or its subcomponents) and analyzes the received information to extract or otherwise determine a set of zero or more features associated with a project entity. The event features may be stored in user activity data 253 and/or made available to pattern inference engine 230 for determining project patterns based on the determined features. For example, common features for different project entities can be used to establish a project pattern.

In addition or instead, entity feature identifier 285 can identify and optionally extract one or more project features of a project entity from content of the data object representing or comprising the project entity and/or metadata of the data object. For a file, this could include file edit data (e.g., last date edited, accessed, date created). Another example includes email sending or receiving data (e.g., times, recipients, senders, and the like).

Entity feature identifier 285 is generally responsible for identifying and optionally determining entity or project features (or variables) associated with the entities that may be used for identifying patterns corresponding to user projects and roles. As indicated above, entity features may be determined from information about an event and/or from related contextual information associated with the project entity. In some embodiments, entity feature identifier 285 receives user-project or related information (e.g., contextual information) from user activity monitor 280 (or its subcomponents) and analyzes the received information to extract or otherwise determine a set of zero or more features associated with a project entity. The event features may be stored in user activity data 253 and/or made available to pattern inference engine 230 for determining project and role patterns based on the determined features. For example, common features for different project entities can be used to establish a project pattern, such as a role.

Personal feature identifier 284 is generally responsible for identifying and optionally determining user features (or variables) associated with the user that may be used for identifying patterns corresponding to user projects and roles. Personal feature identifier 284 may identify user features similar to entity feature identifier 285 (e.g., from events and/or explicit information in user data). However, as opposed to entity features, which characterize or provide semantic information for a particular entity, user features may characterize, describe, or define a particular user.

Examples of personal features include information about user(s) using the device; information identifying a user, such as a login password, biometric data, which may be provided by a fitness tracker or biometric scanner; and/or characteristics of the user(s) who uses the device, which may be useful for distinguishing users on devices that are shared by more than one user. Other examples include demographic information, frequented venues or locations, search history, search queries, known interests (e.g., subjects, concepts, topics), organizational title, hierarchy within an organization, and information derived therefrom. For example, one or more of these personal features may be derived from patterns formed by pattern inference engine 230 and derived from project entities. A role of a user in a project is an example of a personal feature of the user.

As an example, project topics can be extracted from project entities, as will be described in further detail below, and used to associate the user with one or more project topics. When analyzing a particular project entity, the system can leverage previous semantic knowledge of which project topics the user has been active in to determine a probability that the project entity corresponds to one or more of the project topics. This could include comparing the particular entity to the project topic(s) or project entities previously associated with project topics. This probability could be used as a feature in any of the various project entity grouping algorithms described below. It should be appreciated that this concept similarly applies to other properties or combination of properties of project entities other than project topics (e.g., similar search queries, locations, venues).

Examples of entity (e.g., meeting entity) and/or user or personal features include information extracted from requests or communications (e.g., project entities), such as time/date, scheduled duration, invitees, importance, responses (e.g., acceptance, tentative acceptance, declines), proposals or suggestions of alternative times/dates/locations/attendees/other entity features, entity subject(s), file attachments or links in entity-related communications, which may include content of the attachments or links, metadata associated with file attachments or links (e.g., author, version number, date, URL or website-related information); whether the entity is recurring (e.g., a meeting); features from related entities or scheduled entities (where the entity is part of a series, such as recurring meetings or events); location-related features, such as location of an event, location of user device(s) during the event (which may indicate whether a user is present, not present, or attending remotely), venue-related information associated with the location, or other location-related information; time related features, such as time(s) of day(s), day of week or month of the event, or the duration of the event, or related duration information such as how long the user used an application associated with the event or how long a user traveled to attend the event; user device-related features (which in some embodiments may be used for identifying user attendance (physical or remote), participation, and/or involvement at events), such as device type (e.g., desktop, tablet, mobile phone, fitness tracker, heart rate monitor, etc.) hardware properties or profiles, OS or firmware properties, device IDs or model numbers, network-related information (e.g., mac address, network name, IP address, domain, work group, information about other devices detected on the local network, router information, proxy or VPN information, other network connection information), position/motion/orientation related information about the user device, power information such as battery level, user-access/touch information; usage related features, such as file(s) accessed, app usage (which may also include application data, in-app usage, concurrently running applications), network usage information, online activity (e.g., subject related searches, browsed websites, social networking activity related to the entity, communications sent or received including social media posts, user account(s) accessed or otherwise used (such as device account(s), OS level account(s), or online/cloud-services related account(s) activity, such as Microsoft® account or Net Passport, online storage account(s), email, calendar, or social networking accounts, etc.)), features that may be detected concurrent with the event or near the time or the event, or any other features that may be detected or sensed and used for determining a pattern of project-related activity for the user. In some embodiments, event logic 295 (described in connection to event detector 281) may be utilized to identify specific features from project-related information.

Continuing with system 200, pattern inference engine 230 is generally responsible for determining project, role, or meeting patterns based on the various information determined from user activity monitor 280. For example, in some cases, pattern inference engine 230 uses contextual information generated by user activity monitor 280 as context-related entity features, such as for determining semantic information in events to determine a project, role, and/or meeting pattern. Contextual information also may be determined from the user data of one or more users, in some embodiments, which may be provided by user-data collection component 210 in lieu of or in addition to user project information for the particular user. In an embodiment, the contextual information is stored with the corresponding entity in user activity data 253.

At a high level, pattern inference engine 230 may receive project entity data, at least some of which is provided using user activity monitor 280, or its subcomponents, user-data collection component 210 from client-side applications or services associated with user activity monitor 280, and/or user project or event history, which may be stored in user profile 250. One or more inference algorithms may be applied to the entity information to determine project, role, and/or meeting patterns from the project entities identified using project entity identifier 282. For example, patterns may be determined based on similar entity features between project entities or associated personal features, which may be referred to as “in-common features” of entity-related information.

The inferred event pattern information may be provided to model manager 240 and/or used to generate a project, role, or meeting pattern based prediction regarding one or more projects inferred from the project entities. In some embodiments, a corresponding confidence level or score is also determined for the patterns (or predictions based on the patterns), as described herein.

Pattern inference engine 230, or its subcomponents, may operate to analyze project entities, including entity features and optionally personal features, provided by user activity monitor 280. In some cases, personal features could correspond to, for example, historical projects previously identified and/or analyzed with respect to pattern inference engine 230 and/or explicitly acknowledged or otherwise specified by the user.

As shown in example system 200, pattern inference engine 230 comprises historical model identifier 231, and project determiner 236. Historical model identifier 231 is configured to identify a plurality of prior or current projects for a user, which may be considered for determining a project, role, and/or meeting pattern. For example, personal feature identifier 286 may utilize historical model identifier 231 to identify project entities and/or projects from which to extract personal features.

Project determiner 236 is generally responsible for determining projects from user data based on patterns formed in the user data. Project determiner 236 can determine and store various project-related data in association with projects. For example, project determiner 236 may maintain and update a project repository for each project. Project repository 293 of FIG. 2B is an example of a project repository that may be maintained and updated by project determiner 236. By way of example, project repository 293 includes project entities 227, event occurrences 233, role associations 211, project name 209, role feature values 239, content subject matter associations 229, project state associations 217, and project characteristics 219.

Project determiner 236 determining projects from user data can include analyzing project entities with respect to one or more projects based on similarities in project entity information, such as entity features identified by entity feature identifier 285 and, optionally, personal features identified by personal feature identifier 286. For example, the patterns can be used to group or cluster project entities into projects, determine keywords and/or topics of projects, determine roles or projects (and features and characteristics thereof), and update any combination of the forgoing for identified projects. In some cases, this includes project determiner 236 (or pattern inference engine 230) determining potential projects that the user may be associated with by extracting project topics from the project entity information and analyzing patterns formed by project entity information in order to associate project entities with one or more project topics. As new project entity information becomes available to the system (e.g., from newly generated and/or received user data), it can be used to reevaluate and/or update the determinations made by project determiner 236.

In some embodiments, project determiner 236 determines project, role, or meeting patterns using pattern inferences logic 235. Pattern inferences logic 235 may include rules, associations, conditions, prediction and/or classification models, or pattern inference algorithms. The pattern inferences logic 235 can take many different forms depending on the particular project, role, or meeting pattern or the mechanism used to identify a project, role, or meeting pattern, or identify feature similarity among observed project entity data to determine the pattern. For example, some embodiments of pattern inferences logic 235 may employ machine-learning mechanisms to determine feature similarity or other statistical measures to determine the event data belonging to a set of “example user activity” that supports the determined project, role, or meeting pattern. In some embodiments, the project, role, or meeting pattern(s) determined by project determiner 236 may be stored project characteristics 219 and/or provided to model manager 240, which may determine one or more inferred user model(s) 252 from the pattern(s).

Some embodiments of project determiner 236 determine a pattern for projects, roles, or meetings (e.g., project topics) where each project has corresponding historical values of tracked project, role, or meeting features (variables) that form patterns, and where project determiner 236 may evaluate the distribution of the tracked variables for patterns. These project or meeting features and patterns may be utilized as personal features used to analyze new project entities with respect to projects, roles, and/or meetings and/or adjust previously determined associations between project entities and projects. These project features and patterns may also be utilized to personalize content to users based on the projects, roles, and/or meetings, or otherwise be consumed by the various components of project management system 200.

In some cases, the project features are based on project entities previously associated with the project by project determiner 236. In one instance, a tracked variable is associated with a time slot corresponding to an observed instance of the project. Optionally, the tracked variable could further be based on entity features of one or more entities within the time slot. It will be appreciated that, conceptually, many different types of historical values for tracked project features (variables) may be used. Further, it should be appreciated that the project determiner 236 may determine patterns for projects based on any number of features.

In some implementations, project determiner 236 comprises a multistage classifier in which a project entity preclassifier classifies project entities by project topic, a time slot grouper groups, or clusters, time slots by project entities associated with the time slots, and a project entity reclassifier reclassifies the project entities using the project topics by the grouped time slots.

The project entity preclassifier may extract project keywords from project entities and group project entities into project topics corresponding to the keywords. The keywords can be extracted, for example, from content of project entities, and/or metadata of project entities, which can include data object metadata and/or entity features. In some implementations, this includes extracting keywords from text in the content of the data objects represented by the project entities using text-based extraction techniques. For example, keywords can be extracted from emails (e.g., subject line, message body, attachments, and the like), documents accessed during or in association with meetings, meeting invites or other planning or scheduling messages, and the like. It is noted that any suitable keyword extraction techniques may be employed.

In some implementations, project determiner 236 identifies a set of differentiating keywords from the project entities. This can be accomplished, for example, based on determining the frequency of text, such as terms, in a project entity and/or across the project entities and basing the set of differentiating keywords on the frequency of the text. One suitable approach uses term frequency-inverse document frequency. In some cases, the differentiating keywords are extracted by applying a clustering algorithm to the text and project entities, and each differentiating keyword corresponds to a text cluster. Each text cluster can comprise documents or other project entities corresponding to the text cluster. Document classification algorithms may be utilized in various approaches (e.g., unsupervised document classification).

Project determiner 236 may identify and/or extract project topics or concepts from the keywords. Any suitable approach to converting keywords to topics may be employed. In some cases, the keywords (e.g., text clusters) are resolved or mapped to a project topic model. The project topic model can, in some implementations, be generated from the project entities, such as by using a topic model generator that may generate at least some topics from the differentiating keywords.

In some implementations, project determiner 236 resolves keywords to project topics using singular value decomposition (SVD) and non-negative matrix factorization (NMF). SVD may be used as one suitable approach to reducing the keywords down to the most relevant keywords. NMF may be used as another suitable approach to reducing the keywords down to the most relevant keywords in addition to or instead of SVD. These approaches may utilize the text clusters and also may employ entity features of the project entities associated with the text clusters. For example, a keyword may be mapped to a topic based on similarities defined by the project entities corresponding to the keyword.

In some cases, the topic models used and/or generated by project determiner 236 are hierarchical topic models. Using hierarchical topic models, projects and project entities are tracked and analyzed at various resolutions, or granularity. This can be used to present the projects to users at different resolutions, as well as optionally customizing the resolution to the user and/or allowing the user to select the resolution desired for presentation in various contexts. For example, a project topic could be “Client Relations,” and under that project topic could be “customer acquisition” and “customer retention.” Under each of those project topics could be project topics for particular clients.

In order to group the project entities into topics based on similarities between the project entities, project determiner 236 can detect the in-common features between project entities (e.g., from entity features and/or personal features). Project determiner 236 may determine and/or identify similarities for any type of the various entity features described above. Project determiner 236 can apply the in-common features as inputs to the machine-learning algorithms used for topic grouping and/or generation. For example, project determiner 236 may generate one or more matrices from the in-common features to use as inputs for project entity clustering algorithms (e.g., document clustering).

To this effect, project determiner 236 may identify in-common features corresponding to one or more users (e.g., the user) interacting with a project entity. In particular, project determiner 236 may identify each project entity for which it can identify or infer an explicit interaction based on detected user activity, such as an event. Examples include detecting user activity corresponding to a user opening a document, attaching a document to an email, drafting an email, working in an application, and the like. Project determiner 236 can generate one or more matrices of users and/or contacts per project entity from the identified features, which can be input to document clustering algorithms, such as NMF.

Project determiner 236 may also identify in-common features corresponding to a project entity explicitly referencing one or more project entities. In particular, project determiner 236 may identify each project entity for which it can identify an explicit reference to another project entity. Examples correspond to documents attached to an email, documents attached to a meeting, invitees or participants of the meeting, applications, locations, or venues mentioned in or linked from emails or meetings, and the like. Project determiner 236 can generate one or more matrices of references per project entity from the identified features, which can also be input to the document clustering algorithms, such as NMF.

Project determiner 236 may also identify in-common time-related features for the clustering algorithms. For example, each project entity may be associated with one or more times, time slots, and/or time stamps (examples have been described above). The project entities can be grouped into topics based on project determiner 236 determining one or more similarities between these time stamps. For example, the similarity between time-related features may be based on temporal proximity of the time-related features. This may be based on the notion that at least some project entities are more likely to belong to the same project when they are temporally similar. For instance, documents accessed concurrently are more likely to be related to the same project. As another example, emails sent and received within an hour are more likely to be related.

Project determiner 236 may also identify in-common place-related features for the clustering algorithms. For example, each project entity may be associated with one or more venues, locations, and/or GPS coordinates. The similarity between place-related features may be based on location proximity of the place-related features. This may be based on the notion that at least some project entities are more likely to belong to the same project when they are locationally similar. For instance, people may work on projects in particular locations. Thus, documents associated with the office are more likely to be related to the same project. Further, project entities associated with home might be less likely to be associated with project entities associated with the office. For example, those projects may be associated with personal projects.

Project determiner 236 can also group time slots, such as the time slot project entities discussed above. Project determiner 236 may also group the time slots based on the project entities associated with these time slots. For example, project entities related to a time slot may include project entities used to generate the time slot, project entities associated with time stamps within the time slots, events having time stamps within the time slot, project entities corresponding to detected user activity determined to have occurred within the time slot, and the like. Nearest neighbor techniques may be applied to the clustering using entity features of the project entities in association with particular time slots.

Project determiner 236 may also reclassify the project entities it initially classified, as discussed above, based on the clusters of time slots. In doing so, project entities may be moved to different topics based on their corresponding time slots. In further respects, reclassification can be based on one or more personal features of the user, such as those identified by personal feature identifier 286. These include personal features corresponding to the user's search history, the user's role in an organization, characteristics or semantics derived from previous project analysis, the user's position within an organizational hierarchy, known interests of the user, and the like.

As indicated above, in various implementations, the personal features utilized for reclassifying the project entities can be based on previous engagement of the user with other project entities. For example, in some cases, personal features could correspond to project features. These project features could be used to derive a probability that a project entity corresponds to the project. The probability may be based on determining project patterns for project entities that are similar to the project entity. For example, a project pattern for a project may be accessed based on the project pattern being formed by project entities that are the same type of project entity as the project entity (or otherwise identified as similar to the project entity). As an example, the pattern could be formed by meeting type project entities where the project entity corresponds to a meeting. By analyzing the user's historical patterns for a project with respect to a project entity, project determiner 236 can determine a probability, or confidence, that an unclassified project entity corresponds to the project.

To illustrate the forgoing, for a project topic for drafting a sales agreement, the user may not typically schedule or participate in meetings, resulting in a low probability of a meeting corresponding to the project topic. In contrast, for a project topic for drafting a licensing agreement, the user may frequently schedule or participate in meetings, resulting in a high probability of the meeting corresponding to the project topic. It is noted that this approach need not be project specific, and project patterns could be aggregated from different projects, such as by shared characteristics between the projects.

It is noted that for the entity classification and clustering described, project entities need not be limited to single project topics and/or time slots. In particular, associations between project entities and time slots or project topics can be weighted by strength and can vary over time. This may be captured using confidence scores for each project entity. Thus, a single project entity could be strongly associated with multiple project entities, such as may be identified by determining weightings for those project topics that exceed a threshold value, although one of those project topics may be identified as the prominent project topic based on the project entity having the highest weighting for that project topic. These project topics need not share a parent-child relationship in a hierarchical topic model. Further, in some cases, project determiner 236 reclassifies the project entities by adjusting weightings determined during its initial classification.

Using a project entity reclassifier, project entities may be shifted to different projects based on associated time slots. Further, project entities with weightings previously too low to associate with any particular project or project entities not previously analyzed may be associated with one or more projects. This approach may be suitable, for example, for non-textual files, such as audio, video, or picture files, or other project entity types that are sparse or lacking in textual content or metadata. While keyword extraction may be performed on these types of files, it can be inaccurate and processor intensive. By associating these non-textual project entities with time slots grouped by projects, they can be accurately associated with projects. For example, in some embodiments, the keyword extraction is not performed on these types of project entities.

Thus, in some embodiments, project determiner 236 provides project patterns and associated confidence scores regarding the strength of the project patterns. These project patterns may reflect the likelihood that a user will follow the pattern for future events. More specifically, in some embodiments, a corresponding confidence weight or confidence score may be determined regarding a determined project pattern for a user. The confidence score may be based on the strength of the pattern, which may be determined based on the number of observations (i.e., the number of project entities) used to determine a project pattern, how frequently the user activity is consistent with the project pattern, the age or freshness of the activity observations, the number of similar features, types of features, and/or degree of similarity of the features in common with the activity observations that make up the pattern, or similar measurements.

In some instances, the confidence score may be considered when providing a determined project pattern to model manager 240. For example, in some embodiments, a minimum confidence score, or weighting, may be needed before using the project pattern to infer a project or meeting exists based on the pattern. In one embodiment, a threshold of 0.6 (or just over fifty percent) is utilized such that only project patterns having a 0.6 (or greater) likelihood of predicting user actions with regards to a project and/or meeting may be provided. Nevertheless, where confidence scores and thresholds are used, determined patterns of project entities with confidence scores less than the threshold may still be monitored and updated based on additional project entity observations, since the additional observations may increase the confidence for a particular pattern.

In some approaches, bootstrapping is employed. For example, initial project patterns may not be sufficiently strong due to insufficient data; however, project determiner 236 may make a preliminary analysis of project patterns and update those determinations as additional data becomes available to system 200. This additional data may be sufficient to support inferences that projects exist and/or which project entities belong to those projects.

Bootstrapping may be applied, for example, to the hierarchical classification of project topics. Initially, data may be sufficient to infer a project topic applies to the user, but may be insufficient for sub project topics until additional data is received and/or analyzed by system 200 to increase confidence scores for those topics. Additionally, new keywords may introduce new potential project topics into the model. In another approach, several project topics are identified to apply to the user. Similarities are determined between the project topics in order to construct a model. Thus, it should be appreciated that top-down or bottom-up approaches can be employed.

As mentioned previously, model manager 240 uses the various project pattern information from pattern inference engine 230 to create and/or update project models, determine the importance of individual projects, determine the resolution or granularity of projects, name projects, and archive projects. As shown in system 200, model manager 240 includes pattern compiler 242, importance determiner 246, resolution determiner 244, project namer 248, and project archiver 249.

Pattern compiler 242 may operate to compile one or more project patterns for a user determined by project determiner 236 or pattern inference engine 230. In particular, according to a compilation of one or more project patterns, a project model may be determined and used to infer project-related aspects for future projects and/or project entities. In some embodiments, pattern compiler 242 provides a project model for projects at the resolution determined by resolution determiner 244 and/or based on the importance of the project determined by importance determiner 246. In some embodiments, pattern compiler 242 also may gather semantic information, features, categories, and any other project-related data/information available via project management system 200 for use in the project model.

Importance determiner 246 is operable to determine the importance of projects. For example, importance determiner 246 may assign an importance score to each project topic. The importance score can quantify the importance of the project topic to the user relative to other project topics. As another example, importance determiner 246 could assign the importance score to groups of project topics. This may be suitable where a hierarchical mode is employed. For example, an importance score may be generated for the project topic at a resolution selected by and/or inferred for the user (e.g., an importance score for a parent topic may be used for child topics).

In some implementations, importance scores are based on time slots and/or time stamps associated with the projects, and/or the number of project entities within the project. More important projects may be inferred for projects having more project entities. Further, more important projects may be inferred for projects associated with more time slots. As another example, more important projects may be inferred projects that have project entities associated with more recent time stamps and/or time slots. It should therefore be appreciated that importance scores for projects can change over time as new project entities are received and/or processed by pattern inference engine 230 and/or based on elapsing time.

Resolution determiner 244 is operable to determine project resolution for users. Project resolution can refer to a level (e.g., detail level) for a project, which may be in the hierarchical project model. By personalizing the resolution to users, projects can be analyzed at the appropriate level of detail for that user and information about the projects can be determine and provided at the appropriate level of detail for that user. Thus, for example, a manger may have a lower resolution on projects than employees working under the manager, in order to capture a broad spectrum. In contrast, the resolution may be higher and more specific for those employees in order to focus the data presented to those users on their tasks.

This can save processing power, bandwidth, and other computing resources. For example, fewer details may be required by the system for tracking project entities and presenting content to a user at a lower resolution. As another example, for content generated using a higher resolution of a project, the analysis of project entities and patterns can be narrowed from lower resolutions to reduce processing demands (e.g., there is less data associated with a child project topic than its parent so less processing is required).

In some cases, the resolution for a project may be at a default resolution: as additional project entities are analyzed, the system may automatically adjust the resolution. For example, resolution may be changed based on importance scores for project topics and/or roles of users. In one approach, resolution determiner 244 analyzes the importance score for one or more outliers or project topics above a standard deviation or otherwise greater than other projects. Resolution determiner 244 may select the resolution for various projects based on these outliers. For example, if a project topic has an importance score sufficiently greater than each of its child project topics, resolution determiner 244 may set the resolution to that project topic. In some cases, where a resolution is set to a project topic, model manager 240 and pattern compiler 242 process the project at that project topic level, such that project models for the lower level project topics are not individually processed and maintained, thereby reducing computing resources. It should be noted that importance scores may still be updated and generated for each project topic, and may be used to adjust the resolution over time. Further, in some cases, the user may set the resolution or selectively generate views of the project at other project levels.

Project namer 248 may optionally be employed and is generally responsible for naming or labeling projects for users. The names can be presented to the user in association with their corresponding projects to refer to those projects. In other approaches, names may not be required. For example, different projects may be distinguished using a color coding system or other system to visually distinguish projects. In some cases, the names are automatically generated based on the project topics and/or importance scores. In addition or instead, a project name may be based on a resolution of the project for the user (e.g., the project topic at the selected resolution and/or its subtopics).

Project namer 248 can generate project names (e.g., project name 209) that are personalized to users. In addition or instead, project namer 248 can use a system-wide naming scheme to maintain consistency across users. For example, the same project may have the same name for different users, which could be independent of project resolution. It is contemplated that users could additionally have personalized names for projects, which optionally may be set or modified by individual users.

Project archiver 249 is configured to archive projects over time. For example, old inferred projects may be archived based on their importance scores. A project may be archived based on its importance score falling below a threshold value over time. This could occur, for example, based on the system identifying few project entities for the project over a period of time. It is contemplated that archiving a project may be based on user approval and/or direction to archive. Data for an archived project may be maintained, such as project patterns, inferences, project tags, and the like. However, new project entities may be not compared to an archived project, thereby reducing computing resources utilized to identify projects and/or assign project entities to projects.

Some embodiments of the present disclosure further include using project data elements from other users (i.e., crowdsourcing data) for determining project patterns, project models, and/or relevant supplemental content to build project models. Accordingly, in an embodiment, project models may incorporate compiled prior project patterns, crowdsourced event data, detected existing projects, and current user profile activity, among other inferred or gathered data, to construct project models. The generated (or updated) project models may be stored in a user profile 250 associated with the user, such as in user models 252.

Additional Discussion of Engagement Levels and Roles in Projects

As indicated above, aspects of the present disclosure provide for identifying and extracting project roles from user data, and associating the project roles with projects and/or users. Role manager 291 of FIG. 2B may be used to provide this functionality in project management system 200. As shown, role manager 291 includes role identifier 292, role feature determiner 294, engagement lever determiner 297, and role evaluator 298. In some implementations, role manager 291 and its various components may be implemented using project determiner 236, user activity monitor 280, pattern inference engine 230, and model manager 240.

As an overview, role identifier 292 is configured to identify roles from user data. In embodiments where roles are machine learned from project data, this can include grouping (e.g., using a clustering algorithm) different events and other contextual information related to projects into roles, and defining role features for a machine learning model that represents a role that corresponds to a group of the events and other contextual information (e.g., project characteristics). Role feature determiner 294 is configured to determine values of role features. Engagement level determiner 297 is configured to determine engagement levels of users with projects. The engagement levels may be used by role feature determiner 294 for role features. Role evaluator 298 is configured to apply the role feature values to machine learning models that represent the roles, so as to evaluate conformance of users with the roles.

As mentioned above, role identifier 292 is configured to identify roles from user data. In some implementations, project determiner 236 uses role identifier 292 to determine roles of users for projects, where each project has corresponding historical values of tracked project, role, or meeting features (variables) that form patterns, and where project determiner 236 may evaluate the distribution of the tracked variables for patterns. These patterns may be used as role features by role identifier 292 and used to analyze users with respect to roles and/or adjust previously determined associations between users and roles. For example, role features may correspond to any combination of the personal features, entity features, project features, and/or other contextual information described herein.

In some embodiments, role identifier 292 groups different events and other contextual information related to projects based on the users associated with those events. The events can be determined using event detector 281, and the contextual information can be determined using contextual information extractor 286, which may further employ personal feature identifier 284 and/or entity feature identifier 285. Each clustered group may define the events and contextual information associated with a particular role.

The clustering may be performed, for example, such that the events and contextual information that tend to be associated with a common user are clustered into a group. Using this approach, different users may be associated with similar events and contextual information in a project, and be clustered into a common group. In some cases, the grouping is performed for particular projects. However, in others, the grouping may be performed across many projects. This may result in more generic roles with fewer defining events and contextual information.

As indicated above, role identifier 292 can use one or more events and contextual information in a group to define role features for a machine learning model that represents a role that corresponds to the group. To this effect, role identifier 292 may use model manager 240 to extract the role features from elements of the group. For example, as indicated above, model manager 240 can determine characteristics of projects, roles, and/or meetings. As described above, this can be accomplished using pattern inference engine 230. The inferred event pattern information may be provided by pattern inference engine 230 to model manager 240 and/or used to generate a role pattern based prediction regarding one or more projects inferred from the project entities. These characteristics, or patterns, may be used as role features for a machine learning model of a role. In some embodiments, a corresponding confidence score or weighting is also determined for the patterns (or predictions based on the patterns). The confidence score or weighting may be used to weight the corresponding role features in a machine learning model of a role.

Thus, as indicated above, in some implementations, one or more role models may be maintained and tracked separate from project models. A role model (e.g., machine learning model) may capture patterns formed by previous events of at least one user, such as the user associated with user profile 250. These patterns can be formed by entity features of the project entities, such as those determined by entity feature identifier 285 for project entities 227. A characteristic derived from a pattern for a model can correspond to a typical feature for a user(s) associated with the role. Thus, when similar characteristics are determined for a user, the characteristic can indicate the user is likely to have a particular role (e.g., the user can be associated with a role using its machine learning model). As another example, a role model may be determined from an aggregate of project entities from a subset of the projects (e.g., project topics) identified by project determiner 236 for a user. A characteristic derived from such a model can correspond to a typical feature for a role related to the subset of projects (i.e., one or more projects) associated with the user.

In some embodiments, weightings for role features of the machine learning model for a role may optionally be determined by extracting patterns from values associated with the events and other contextual information such that a weight corresponds to a strength of an extracted pattern. The weightings can be determined such that the more indicative a role feature is of a role, the higher its weighting.

The roles identified using role identifier 292 can serve as predefined roles used by role evaluator 298 to assign roles to users. In some cases, role identifier 292 does not identify one or more of the predefined roles using pattern recognition and analysis approaches described herein, but still may adjust weightings of role features using pattern recognition and analysis.

As mentioned above, personal features, entity features, project features, and/or other contextual information described herein may be used as one or more role features, and/or role identifier 292 may derive one or more role features from any combination of that information. Role evaluator 298 uses role feature determiner 294 to determine values of the role features for a user to apply the role features to the machine learning models that represent the roles, so as to evaluate conformance of users with the roles and assign users to those roles.

In some cases, role feature determiner 294 analyzes one or more user conversations, such as conversational data of the conversations, to determine one or more role feature values for one or more users. As used herein, “conversational data” of a conversation refers to at least some of the messages comprising the conversation and/or at least some of the contextual information associated with the conversation. A conversation may refer to a temporally related set of messages between users in which information is exchanged. In some cases, the set of message may correspond to a meeting, such as a calendar meeting. While some of the messages may be exchanged during a scheduled time for the meeting, others may occur before or after, but still may be linked to the conversation at least partially using the scheduled time for the meeting. The set of messages may further be related by subject matter, such as a common project, or other topics. A conversation that role identifier 292 may analyze can be captured by any suitable digital medium and in some cases is facilitated by one or more digital services, such as applications. For example, one or more digital services may be used to manage and track the exchange of conversational messages (i.e., the messages that comprise the conversation) between the users. Examples include instant messaging programs, email programs, chat programs, video chat programs, Voice over Internet protocol (VoIP) programs, text messaging programs, conferencing programs, and more. Examples of the digital mediums include instant messages, emails, streaming or live video, a video file, streaming or live audio, an audio file, VoIP and/or phone transmissions, text messages, recordings, records, or logs of any combination of the forgoing, and more.

It should be appreciated that a conversation detectable by role feature determiner 294 (e.g., using user activity monitor 280 including any combination of the various components thereof) may occur cross-service and/or cross digital medium. For example, the same conversation could include a user texting another user and the other user emailing the user a response. In other cases, role feature determiner 294 could use transitions to new services to delineate new conversations and/or meetings. It is further noted that role feature determiner 294 can detect a conversation in real time, as it is occurring (e.g., from streaming data), and/or after it has completed (e.g., from log data). For example, a meeting may be detected from an audio feed of a conversation captured by one or more user devices (e.g., a mobile phone).

Role feature determiner 294 may determine values of role features for users with respect to particular projects by analyzing occurrences of events that are associated with the projects with respect to the users. The role feature values for a project may be stored in its associated project repository. For example, role feature values 239 may be stored in project repository 293.

In determining a value of a role feature, the value may increase as the user is more frequently associated with event occurrences 233 for the one or more events corresponding to the role feature, or decrease as the user is less frequently associated with such event occurrences (e.g., indicating a transition out of a role as a project wraps up or the role is taken over by another user). Further, different events or types of events may be weighted differently. For example, one or more events in which the user is an entity that generated at least some of the user activity data may be weighted higher than one or more events in which the user is not an entity that generated at least some of the user activity data.

An example of events used by role feature determiner 294 to determine role feature values includes conversation events of users. Each event could correspond to a conversational event, such as a conversational email or other message sent by the user and/or a verbal conversational event in a meeting. In some implementations, the characteristics of projects (e.g., project characteristics 219) that role feature determiner 294 uses to determine values of role features include characteristic keywords used in the projects and/or meetings. The keywords can include individual keywords and/or keyword phrases extracted from project entities 227 associated with the project. For example, the characteristic keywords can include at least some of the differentiating keywords described above.

The keywords may be associated with particular users, such as based on corresponding to project entities associated with those particular users (e.g., based on detected events associated with the user). For example, the keywords may be weighted for a user, such as by their frequency of detection in project entities associated with the user for a project. The higher the weighting the more representative the keyword (or keyword phrase) may be of a user's involvement with particular content subject matter of a project. Keywords may be used as content subject matter categories and/or aggregated into content subject matter categories that define the subject matter of project entities associated with the project. For example, role evaluator 298 can determine the content subject matter categories as topics from the keywords (e.g., keyword phrases) and/or other conversational data. In some cases, this can be accomplished similar to determining project topics, described above. For example, the project topic model used to determine project topics may be used to determine content subject matter categories.

In aggregating keywords, keyword weightings may be averaged or otherwise combined for a set of keywords role evaluator 298 associates with a particular user or users, which may be captured in content subject matter associations 229. Role evaluator 298 can use the content subject matter associations of a user as one or more role features and/or to derive one or more role features of a role to evaluate the role with respect to the user. In some cases, only keywords having a threshold weighting may be used to identify roles. In addition or instead, role evaluator 298 could select a predetermined number of top-weighted keywords to use to identify roles. It should be appreciated that the keywords used for determining role feature values can change as additional project entities are analyzed and additional project entities are identified.

In some cases, one or more role features correspond to variance in the content subject matter categories associated with a user. For example, some roles may be characterized by high variance in the content subject matter categories, whereas other roles may be may be characterized by a lower variance in the content subject matter categories. As an example, a project leader role may be involved with all aspects of a project, and therefore be associated with high project variance, whereas an active participant role may be involved with a narrow range of content subject matter for the project.

In addition to or instead of content subject matter categories, one or more features used by role models evaluated by role evaluator 298 may correspond to project state categories assigned to the occurrences of the events. The project state categories associated with users may be stored as project state associations for a project. For example, project state associations 217 are stored as project state associations for the project corresponding to project repository 293. A project state category may refer to a category that represents a state of a project, such as a milestone, a decision point, a status check, and the like. In various implementations, role evaluator 298 may determine project state categories of project entities and/or events associated with the project entities, and determine project state category associations of users based on the project state categories of ones of project entities and/or events the users are associated with. For example, some roles may be involved with milestones, but not status checks, which may be reflected in role features for particular roles. Role evaluator 298 may determine project state categories using, for example, natural language processing and/or keyword identification techniques on project content.

In addition to or instead, one or more features used by role models evaluated by role evaluator 298 may correspond to an event comprising a user providing feedback on one or more aspects of the project. For example, conversational data may indicate a user is providing feedback on one or more aspects of the project to another user, which can be determined by role evaluator 298 evaluating project entities and other contextual information associated with the event.

In addition to or instead, one or more features used by role models evaluated by role evaluator 298 may correspond to an event comprising a user assigning a task of a project to one or more other users. For example, conversational data may indicate a user is assigning a task to another user, which can be determined by role evaluator 298 evaluating project entities and other contextual information associated with the event.

In addition to or instead, one or more features used by role models evaluated by role evaluator 298 may correspond to an event comprising a user being assigned a task of a project by one or more other users. For example, conversational data may indicate a user is assigned a task by another user, which can be determined by role evaluator 298 evaluating project entities and other contextual information associated with the event.

In addition to or instead, one or more features used by role models evaluated by role evaluator 298 may correspond to an event comprising a user producing content of an output of a project. For example, conversational data may indicate a user is producing or has produced content of an output of a project, which can be determined by role evaluator 298 evaluating project entities and other contextual information associated with the event.

In addition to or instead, one or more features used by role models evaluated by role evaluator 298 may correspond to an event comprising a user setting one or more priorities for a project. For example, conversational data may indicate a user has set one or more priorities for a project, which can be determined by role evaluator 298 evaluating project entities and other contextual information associated with the event.

In addition to or instead, one or more features used by role models evaluated by role evaluator 298 may correspond to an event comprising a user causing a change in one or more priorities and/or plans for a project. For example, conversational data may indicate a user has caused one or more priorities and/or plans for a project to change, such as based on the user's feedback, which can be determined by role evaluator 298 evaluating project entities and other contextual information associated with the event.

In addition to or instead, one or more features used by role models evaluated by role evaluator 298 may correspond to an event comprising a user receiving an output of a project. For example, conversational data may indicate a user has received an output of a project, which can be determined by role evaluator 298 evaluating project entities and other contextual information associated with the event.

In addition to or instead, one or more features used by role models evaluated by role evaluator 298 may correspond to an event comprising a user providing opening remarks and/or closing remarks to a meeting and/or section of a meeting. For example, conversational data may indicate a user has provided opening remarks and/or closing remarks to a meeting and/or section of a meeting, which can be determined by role evaluator 298 evaluating project entities and other contextual information associated with the event.

In addition to or instead, one or more features used by role models evaluated by role evaluator 298 may correspond to an engagement level of a user with a project, which may be determined using engagement level determiner 297. An engagement level may quantify a user's involvement with a project. Engagement levels of users with projects may be stored as project characteristics of a project. For example, engagement levels of users with the project corresponding to project repository 293 may be stored in project characteristics 219.

In order to determine an engagement level of a user with a project corresponding to project repository 293, engagement level determiner 297 may determine which of event occurrences 233 that are associated with the project are associated with the user. An event occurrence may be associated with the user based on determining the user activity of the occurrence includes user activity data of the user. This may involve the user being an entity that generated at least some of the user activity data. For example, the user may assign a task to another user. As another example, an event occurrence may be associated with the user based on determining the user activity data of the occurrence explicitly or implicitly mentions the user. This may involve the user being referenced in the user activity data, such as by another entity that generated at least some of the user activity data. For example, another user may assign a task to the user.

Engagement level determiner 297 may determine an engagement level based on a frequency of occurrences of events for the user with respect to a project. For example, the engagement level may increase based on an increase in the frequency of the user being associated with event occurrences 233. Further, different events or types of events may be weighted differently in an engagement level. For example, events in which the user is an entity that generated at least some of the user activity data may be weighted higher than events in which the user is not an entity that generated at least some of the user activity data.

An example of events used by engagement level determiner 297 to determine engagement levels includes conversation events of users. For example, an engagement level for a user may be based on how frequently and/or how long a user converses. Each event could correspond to a conversational event, such as a conversational email or other message sent by the user and/or a verbal conversational event in a meeting. As an example, other factors being equal, users that talk more in meetings related to a project may have higher engagement levels than users that do not talk more in meetings related to the project.

Additional examples of roles and role features of roles are provided below. The examples emphasize various factors that may distinguish the role, which may include any combination of the factors used for role features described above. In some embodiments, factors that are not specifically set forth for a role may or may not be used as a role feature for the role. As an example, each role could use similar role features, but weight those features differently in determining a conformance of a user with the role. In some embodiments, each user may be assigned a single role, such as a role that has a highest confidence level or score for the user. As another example, each user may be assigned multiple roles, such as each role for which the confidence level or score exceeds a threshold value.

A leader role may correspond to one or more users that lead a project. A machine learning model associated with the role may result in a high association of a user with the role based on the user having a high engagement level with the project. Further, a machine learning model associated with the role may result in a high association of a user with the role based on the user frequently setting priorities for the project. Thus, at least these factors may be accounted for in role features for the role.

An active participant role may correspond to one or more users that actively work on parts of the project. A machine learning model associated with the role may result in a high association of a user with the role based on the user frequently working on and/or producing project content. Further, a machine learning model associated with the role may result in a high association of a user with the role based on the user having a high engagement level with the project. Thus, at least these factors may be accounted for in role features for the role.

A reviewer role may correspond to one or more users that review one or more parts of a project. A machine learning model associated with the role may result in a high association of a user with the role based on the user having a low engagement level with the project, as users with this role may not be engaged in the day-to-day aspects of the project. Further, a machine learning model associated with the role may result in a high association of a user with the role based on the user frequently being associated with providing feedback on project content and/or project state categories corresponding to a milestone, a decision point, and/or a status check. Further, a machine learning model associated with the role may result in a high association of a user with the role based on the user frequently being associated with causing a change in project plans and/or priorities. Thus, at least these factors may be accounted for in role features for the role.

An advisor role may correspond to one or more users that provide advisement to a project in one or more specific areas of expertise. A machine learning model associated with the role may result in a high association of a user with the role based on the user being associated with a low variance in content subject matter categories. Further, a machine learning model associated with the role may result in a high association of a user with the role based on frequently providing user feedback on the project in relation to the content subject matter categories. Thus, at least these factors may be accounted for in role features for the role.

An informed role may correspond to one or more users that are frequently updated on the project. A machine learning model associated with the role may result in a high association of a user with the role based on the user having a low engagement level with the project. Further, a machine learning model associated with the role may result in a high association of a user with the role based on the user frequently receiving project updates. For example, the user may be frequently associated with events related to a milestone, a decision point, and/or a status check for a project. Thus, at least these factors may be accounted for in role features for the role.

A consumer role may correspond to one or more users that consume outputs and/or deliverables of a project, such as a customer. A machine learning model associated with the role may result in a high association of a user with the role based on the user having a low engagement level with the project. Further, a machine learning model associated with the role may result in a high association of a user with the role based on the user frequently receiving project outputs and/or deliverables. Further, a machine learning model associated with the role may result in a high association of a user with the role based on being frequently associated with events related to a milestone for a project. Thus, at least these factors may be accounted for in role features for the role.

A sponsor role may correspond to one or more users on behalf of whom a project is undertaken. A machine learning model associated with the role may result in a high association of a user with the role based on the user having founded the project. Further, a machine learning model associated with the role may result in a high association of a user with a role based on being frequently associated with events related to a milestone for a project. At least these factors may be accounted for in role features for the role.

Interface manager 260 is generally responsible for facilitating the consumption of data generated from project patterns and/or models by consumer applications or services. In some embodiments, interface manager 260 operates in conjunction with presentation component 220 to provide a user interface for providing and/or interacting with data of an identified project or role. In doing so, content can be personalized to the user based on the projects and roles associated with the user. Presentation component 220 generally operates to render various user interfaces or otherwise provide information generated by project management system 200 and the components thereof in a format that can be displayed on a user device. By way of example, presentation component 220 may render a project or meeting management service interface for receiving project and meeting settings, which may be stored in user preferences 254. Examples of the settings have been described above and include project resolutions, project names or nicknames, and the like. Presentation component 220 may further render a project or meeting informational service for presenting project and role details provided by interface manager 260.

Embodiments of interface manager 260, and/or its subcomponents, may run on a single computing device, across multiple devices, or in the cloud. For example, in one embodiment where interface manager 260 operates in conjunction with features provided by Microsoft® Exchange, interface manager 260 may reside, at least in part, on an Exchange server, which may be embodied as server 106 in FIG. 1. Further, presentation component 220 may at least partially be embodied as user device 102a.

Interface manager 260 includes meeting manager 259, history determiner 262, message manager 264, item ranker 266, and entity tagger 268. Entity tagger 268 is operable to tag project entities with corresponding projects. Tagging a project entity can include storing a project's tag in the project entity in association with the project. This can include a project identifier, a project name (as described above), an importance indicator (e.g., corresponding to the project's importance score), a confidence score for each project (e.g., a level of confidence the project entity corresponds to the project), role assignments or associations for each project, and/or a project resolution level or project hierarchy indicator. In some cases, entity tagger 268 tags projects with a subset of identified projects, such as those having the highest importance scores in conjunction with the importance scores exceeding a threshold value.

Presentation component 220 can utilize the project tags to present the projects and meetings to users. For example, a project or meeting may be displayed in association with information from its project tag, such as its project name and associated users and their roles. Further, presentation component 220 may present the project or meeting based on its project resolution level and importance level or score.

History determiner 262 is operable to provide project summaries, analysis, and efficiency suggestions, which can be presented by presentation component 220. To do so, pattern inference engine 230 can analyze project features corresponding to project time slots and corresponding project entities for one or more particular roles. History determiner 262 may further surface suggested applications based on project history, such as frequently used applications detected from user activity associated with one or more particular roles.

History determiner 262 can identify the times a user having the one or more particular roles worked on or will work on a project and expose it to users. This could include generating a summary of projects and time over a user-specified time period (e.g., weekly, monthly, daily) for one or more particular roles. History determiner 262 can employ item ranker 266 for project-based queries, which is described below in additional detail. History determiner 262 could also process time-related queries against projects, such as determining when user associated with one or more particular roles was involved in an event associated with a project or surfacing documents based on the project's lifecycle, allowing users to understand the project lifecycle.

It is noted that history determiner 262 can be forward looking. For example, project entities may be incorporated into the project history that have not yet occurred or elapsed. Thus, a user may request or otherwise be provided with a summary for a project(s) of an upcoming week, day, or other time period.

Message manager 264 may act as a gateway to messages and notifications being presented to a user based on user role assignments and/or may determine which users to send which messages based on user role assignments. Message manager 264 can, in some implementations, monitor and analyze incoming messages and notifications and determine whether to permit those communications to be presented on a user device. To do so, message manager 264 may determine whether a communication corresponds to one or more particular projects and/or roles. For example, message manager 264 can determine whether to block or permit one or more communications from being presented based on which projects and/or roles they correspond to or to which they fail to correspond. To do so, message manager 264 may analyze a message with respect to known project entities identified for a project, including whether the message corresponds to a contact, includes one or more project keywords or terms, and the like.

In some cases, message manager 264 blocks or permits the one or more communications (e.g., emails, phone calls, text messages, push notifications) based on determining that the user is engaged in the project. For example, identified project relevant communications can be presented and the non-project relevant communications that are identified may be blocked from presentation. Message manager 264 may determine the user is engaged in the project via various approaches. In some cases, message manager 264 may determine the user is in a meeting corresponding to the project. As another example, message manager 264 could make such a determination by comparing user activity (e.g., current activity or previous) with respect to project features. This can include determining a probability the user will be or is engaged in the project. For example, detected interactions with applications, contacts, and/or time periods (e.g., day of week, time of day, week of month or year, month of years) frequently associated with a project can indicate the user is engaged in the project. In addition or instead, the user may explicitly label a meeting or time slot with a project tag that message manager 264 uses to identify project engagement.

Item ranker 266 is operable to rank items with respect to associations between users and roles. This could be used to facilitate processing of searches with respect to projects, meetings, emails, and/or roles. For example, item ranker 266 can process search queries against project tags and/or meeting data (e.g., meeting keywords and/or meeting summaries) based on roles. This can allow, for example, a user via presentation component 220 to search for each file related to one or more particular projects, project entities, and/or roles, which may optionally specify a particular project entity type, content subject matter category and/or project state category for search results. As an example, a user can search for project entities related to a meeting based on the time slot and/or conversational data of the meeting and the roles associated with the user (e.g., identified by mapping users to roles). For example, the user could provide the time-based natural language query “show me the documents an auditor role discussed in a meeting during June of last year.” The search results can be presented on a user device associated with the user. In some cases, item ranker 266 ranks project entities against search queries. For example, item ranker 266 can rank project entities by their confidence scores and/or importance scores. Optionally, item ranker 266 processes search queries that specify one or more time periods or ranges to search for project entities associated with one or more particular roles. In implementations where time slots are clustered to projects and meetings, these queries can efficiently be resolved with low processing requirements.

Item ranker 266 can also operate to personalize other types of searches to users. For example, web searches, document searches, email inbox searches, contact searches, and the like can be personalized based on project data such as meetings and roles. For example, search entities can be compared to project features and/or project entities (e.g., meetings and roles), and the ranking of the search entities can be based on their similarities to the project data. In further respects, in some cases, these searches could be performed by a personal assistant running on a user device, such as to interpret a user command or query, or otherwise return results to the user input based on processing the input against project data. As an example, suppose a user provides a voice command, “Call John.” Assume the user has many contacts named John. Item ranker 266 can determine the user is or will be engaged in a project (e.g., meeting), and further resolve the command to “John Smith,” based on determining that the contact corresponds to the project (e.g., that the contact may be a project entity associated with the project). Thus, the user need not specify additional details about the subject of the query in the command. This can, for example, reduce the bandwidth and storage size required to transmit the voice commands to the server, as well as avoid follow-up user prompts and/or user commands.

As mentioned above, project entities may include contacts and/or users. Thus, in some embodiments, item ranker 266 can rank users and/or contacts of a project with respect to project-related search criteria that may include project roles, project features, engagement levels, level of detail, project state categories, content subject matter categories and/or project entities (examples of which are provided throughout the present disclosure). As an example, a user may provide search criteria specifying a particular role(s), and item ranker 266 may analyze project repository 293 to rank the users stored in project entities 227 by similarity to the particular roles (e.g., using the confidence scores describes above). In another example, item ranker 266 may associate user with particular roles in advance and return one or more users that satisfy the search criteria.

Thus, using approaches described herein, users or services can access project repository 293 to identify the most relevant user or users to contact for a project. For example, this may be accomplished using a search query and/or search that specifies search criteria including any combination of project roles, project features, project state categories, content subject matter categories, time based criteria, and/or project entities. Thus, a user or service may use the search results to identify which users have leader roles, which users have active participant roles, and the like, which may be for a specified period of time of the project. As an example, history determiner 262 may leverage these types of searches in generating a summary of a project, as mentioned above. As another example, message manager 264 may user the search results to identify appropriate users or contacts to receive messages that will be sent or to route or reroute already sent messages. For example, message manager 264 may be integrated into a message program like an email program and may convey to a user suggested recipients for an email by generating the search criteria at least partially from the email (e.g., the body of the email or other message, attachments of the email, subjects of the email, etc.). As a further example, item ranker 266 may rank a plurality of emails (e.g., content, which may be filtered to a particular project(s)) for a user, which causes one or more of the plurality of the emails to be displayed to the user in an inbox based on the ranking.

In some embodiments, information from project or role models may be displayed or made accessible via interface manager 260 and presentation component 220. A user may be able to access aspects of and view his or her project or meeting models. This may provide an opportunity for the user to see patterns and trends that may be reflected in their models. Further, in some instances, the models of other user profiles and/or aggregated models (which may remove identifying information, in some instances) may also be generated for display. Moreover, some embodiments of the invention may construct a complementary or shadow calendar for one or more users, based on the associations between projects and time slots, which may be displayed to one or more users.

In further respects, history determiner 262 may identify a new or recent participant to join a project. For example, the participant may be detected in a meeting (e.g., conversation). Based on history determiner 262 determining the participant does not correspond to a characteristic project participant, interface manager 260 may provide access to one or more documents or files, summaries, or other information associated with the project. This could include automatically sharing the data with the user and/or providing one or more links to the information.

Furthermore, in some cases, message manager 264 uses history determiner 262 to determine whether to provide access to one or more documents or files, summaries, or other information associated with the project. For example, a user may be provided access to project entities based on history determiner 262 determining the project entity is newly associated with a project, or has been changed and/or modified. Message manager 264 uses history determiner 262 in combination with the project repository to determine which users to send messages to, such as based on roles associated with the users, similarities in content subject matter associations 229 of the user to that of project entities, and/or relations between project entities and project state associations associated to the users and/or roles. This may involve history determiner 262 classifying and/or tagging project entities of projects with roles, and message manager 264 using the classifications and/or tags to identify project entities associated with particular roles. It should be appreciated that item ranger 266 may similarly leverage the classifications and/or tags to rank items based on roles.

Meeting manager 259 is configured to manage meetings on behalf of users based on roles. For example, meeting manager 259 may associate a meeting with a project based on comparing project characteristics of the project to meeting context of the meeting. This may be used to determine what roles should be involved in the meeting. Based on the meeting context of the meeting and the role of the user, meeting manager 259 can select a user as an attendee for the meeting. For example, the comparison may indicate that one or more particular roles should be involved in the meeting and select the user based on the user being associated with the roles for the project. Meeting manager 259 may further cause a notification to be sent to one or more users, such as the selected user(s) based on the selecting of the user as the attendee.

In various implementations, meeting manager 259 may analyze a list of users that have accepted a meeting request, and automatically reschedule the meeting based on determining that one or more roles that should be involved in the meeting have not accepted or confirmed the meeting request and/or declined the meeting request. Meeting manager 259 may, for example, determine one or more users that have one or more roles, such as from the list of users and/or the project repository. Meeting manager 259 may access calendar data of the determined one or more users and automatically suggest or automatically select and reschedule to one or more meeting time slots that fit in the schedule of the one or more users. Adjusted meeting time slots and/or suggestions may be included in a notification to one or more users associated with the meeting. In some cases, meeting manager 259 may identify users that should attend the meeting based on their engagement levels with the project, which may or may not be captured by the role features of their role. As one example, meeting manager 259 may select a user for a meeting based on the user being associated with a role that it determines should attend the meeting based on a similarity of the meeting to a project state associated with the role and the engagement level of the user exceeding a threshold value. As another example, where multiple users are associated with a role, a subset of those users may be selected based on their engagement levels and/or other factors, such as similarities between content subject matter associations 229 of the users and the meeting.

In various embodiments, interface manager 260 may leverage resolution determiner 244 to determine a level of detail for a user based on, for example, a role and/or engagement level of the user. For example, any combination of history determiner 262, meeting manager 259, message manager 264, and entity tagger 268 may use the level of detail to determining what content to provide to users and/or a level of detail for particular content. As example, a level of detail for a particular user may be associated with content and used by any of those components to determine whether to filter out the content from being provided to the user when the level of detail fails to exceed a threshold level. In some embodiments, a level of detail for a user for content is based on a ranking score determined by item ranker 266 (described further below) based on search criteria determined by resolution determiner 244 and submitted to item ranker 266. For example, the search criteria may be based on the content and other information, such as the role of the user.

In addition, or alternatively, the level of detail may be used by any of those components to determine a scope of the content to provide to the user and/or generate for the user. As an example, history determiner 262 may use the level of detail to generate for a user a particular version of a summary of project(s), a summary of a project content, and/or other content related to a project, and/or to determine which version of that content to provide to the user. History determiner 262 may summarize content using any suitable approach, such as text summarization for particular documents and/or combination of documents. The level of detail may impact a length of a summarization and/or level of generality of the summarization.

As indicated above, based on determining a user is a manger, resolution determiner 244 may assign the user a lower project resolution for particular content or project content in general compared to employees that are determined to work under the manager. Thus, the level of detail for the employees may be higher and more specific in order to focus the data presented to those users on their tasks. Resolution determiner 244 may identify the manager based on determining the user has one or more particular roles, such as a leader role, an advisor role, an informed role, a sponsor role, and a reviewer role. Further resolution determiner 244 may identify the employees working under the manager based on determining those users have active participant roles, or another manager role that hierarchically falls under the role of other manager.

In addition, or alternatively, resolution determiner 244 may determine a level of detail for a user based on one or more of project state associations 217 (e.g., project state categories) and/or content subject matter associations 229 (e.g., content subject matter categories) of the user. For example, project state associations 217 may capture levels of association between project state categories and particular users and/or roles. When determining a level of detail for content for a user, resolution determiner 244 may identify one or more project state categories associated with the content, and level of detail may increase for higher the levels of association between the one or more project state categories and the user and/or role associated with the user. Thus, a user or role often involved in or highly related to project milestones may receive a higher level of detail on content associated with that milestone than another user that is less related.

As a further example, content subject matter associations 229 may capture levels of association between project state categories and particular users and/or roles. When determining a level of detail for content for a user, resolution determiner 244 may identify one or more content subject matter categories associated with the content, and level of detail may increase for higher the levels of association between the one or more content subject matter categories and the user and/or role associated with the user. Thus, a user or role often involved in coding a product may receive a higher level of detail on content associated with that content subject matter category than another user (e.g., that may instead be associated with marketing the product).

Thus, different roles and/or users may be associated with different levels of detail for the same content depending on being associated with different roles, different project state categories and/or content subject matter categories, and/or depending on having different levels of association with those categories.

As mentioned above, using resolution determiner 244, interface manager 260 may provide different content to users based on their roles (e.g., by filtering content based on levels of detail). For example, some roles may receive content independent of content subject matter associations 229, but the content may be filtered by project state associations 217 that are associated with the content. As another example, some roles may receive content independent of project state associations 217 but the content may be filtered by subject matter associations 229 that are associated with the content. As a further example, some roles may be filtered by both subject matter associations 229 and project state associations 217 that are associated with the content.

To illustrate as example of interface manager 260 suing resolution determiner 244, the user having the leader role may receive content for a project related to coding a product and marketing a product, which may be captured in content subject matter associations 229. In contrast, one of the users having an active participant role may only receive content for the project related to coding the product (and/or other content subject matter categories associated with the user or role), and another of the users having an active participant role may only receive content for the project related to a marketing the product (and/or other content subject matter categories associated with the user or role). Further, as indicated above, the content for the user having the leader role may be less detailed for the other users based on their roles.

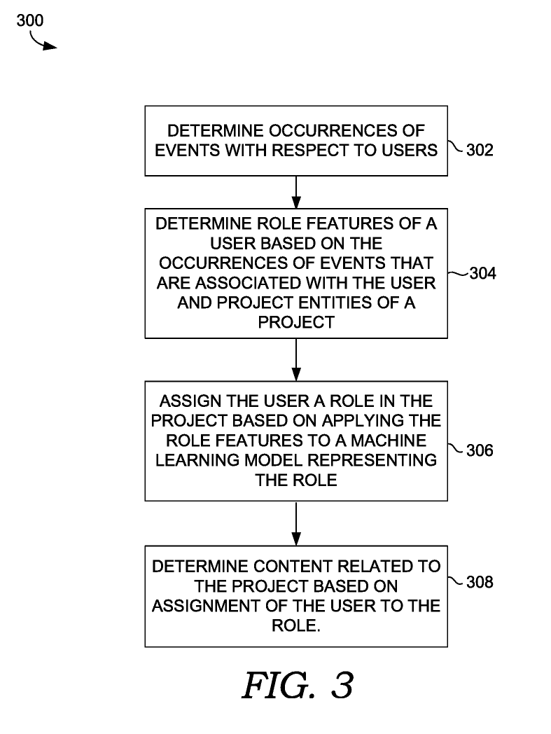

Turning now to FIG. 3, a flow diagram is provided that illustrates method 300 for associating roles with users in accordance with implementations of the present disclosure. As shown at block 302, method 300 includes determining occurrences of events with respect to users. For example, event detector 281 can determine, from user activity data captured from sensor data from at least one user device (e.g., user device 102a) using user-data collection component 210, events with respect to users. This may include associating one or more particular users with each event, such as based on the one or more particular users exhibiting the user activity of the event.

At block 304, method 300 includes determining role features of a user based on the occurrences of events that are associated with the user and project entities of a project. For example, role feature determiner 294 can determine role feature values of a user based on the occurrences of events that are associated with the user and project entities 227 of a project corresponding to project repository 293.

At block 306, method 300 includes assigning the user a role in the project based on applying the role features to a machine learning model representing the role. For example, role identifier 292 can assign the user a role based on applying the role features for the user to the model of role models 221 that represents the role. For example, the model could output a binary indicator of whether the user corresponds to a role. As another example, the model could output a similarity score that represents the similarity between the user's activity and the role. The role could be assigned to the user based on the similarity score exceeding a threshold value. In addition or instead, the role features could be applied to each role model 221 and a single role may be assigned that has a highest similarity score for the user, or multiple roles could be assigned to the user. Blocks 304 through 306 could be performed for each user associated with a project and assigned roles may be stored in role associations 211.

At block 308, method 300 includes determining content related to the project based on the assignment of the user to the role. For example, interface manager 260 can personalize content to the user based on the assignment of the role to the project. The personalized content can be presented on a user device using presentation component 220. Personalizing content to a user may refer to generating content or providing content based on information corresponding to user data associated with the user. Examples of the information include any of the various information stored in user profile 250 and/or project repository 293 associated with the user, such as roles assigned to the user and/or engagement levels of the user with projects.

Examples of personalized content are described throughout and could comprise, for example, any of the various content provided by presentation component 220 (e.g., information populating a user interface) which in addition to what has been described above, can include values for fields in a template, such as a content card, an email, a push notification, a text message, or other message or visualization, which may be provided to the user. This could include suggestions, recommendations, and the like that are generated based on the user data.

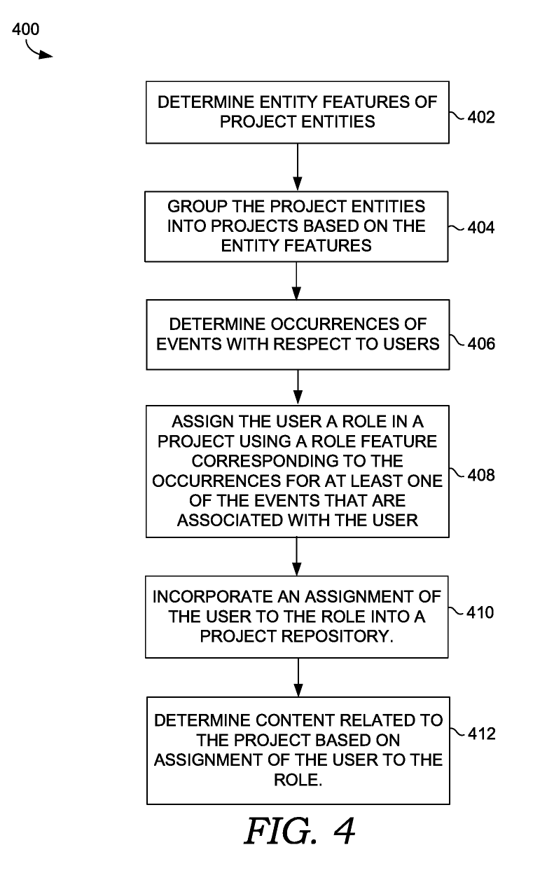

With reference to FIG. 4, a flow diagram is provided that illustrates method 400 for associating roles with a user in accordance with implementations of the present disclosure. At block 402, method 400 includes determining entity features of project entities. For example, entity feature identifier 285 can determine entity features of project entities including project entities 227 and other project entities.

At block 404, method 400 includes grouping the project entities into projects based on the entity features. For example, project determiner 236 may group the project entities into projects based at least in part on patterns formed by the entity features between the project entities.

At block 406, method 400 includes determining occurrences of events with respect to users. For example, event detector 281 can determine, from user activity data captured from sensor data from at least one user device (e.g., user device 102a) using user-data collection component 210, events with respect to users. This may include associating one or more particular users with each event, such as based on the one or more particular users exhibiting the user activity of the event.

At block 408, method 400 includes assigning the user a role in a project using a role feature corresponding to the occurrences for at least one of the events that are associated with the user. For example, role identifier 292 can assign the user a role based on applying a role feature for the user to the model of role models 221 that represents the role. For example, the model could output a binary indicator of whether the user corresponds to a role. As another example, the model could output a similarity score that represents the similarity between the user's activity and the role. The role could be assigned to the user based on the similarity score exceeding a threshold value. In addition or instead, the role features could be applied to each role model 221 and a single role may be assigned that has a highest similarity score for the user, or multiple roles could be assigned to the user.

At block 410, method 400 includes incorporating an assignment of the user to the role into the project repository. For example, based on the assigning of the user to the role, role manager 291 may record an assignment of the user to the role into role associations 211 of project repository 293 of the project.

At block 412, method 400 includes determining content related to the project based on the assignment of the user to the role. For example, interface manager 260 can determine, based on one or more of role associations 211 in project repository 293, a notification in association with the project. As an example, this may be an alert for the user when project content relevant to the role of the user has changed and/or been added to the project.

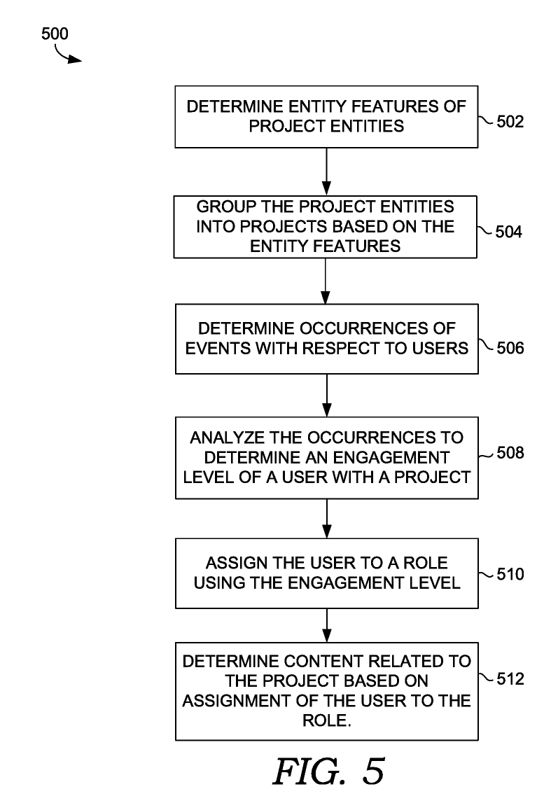

With reference to FIG. 5, a flow diagram is provided that illustrates method 500 for associating roles with users in accordance with implementations of the present disclosure. At block 502, method 500 includes determining entity features of project entities. For example, entity feature identifier 285 can determine entity features of project entities including project entities 227 and other project entities.

At block 504, method 500 includes grouping the project entities into projects based on the entity features. For example, project determiner 236 may group the project entities into projects based at least in part on patterns formed by the entity features between the project entities.

At block 506, method 500 includes determining occurrences of events with respect to users. For example, event detector 281 can determine, from user activity data captured from sensor data from at least one user device (e.g., user device 102a) using user-data collection component 210, events with respect to users. This may include associating one or more particular users with each event, such as based on the one or more particular users exhibiting the user activity of the event.

At block 508, method 500 includes analyzing the occurrences to determine an engagement level of a user with a project. For example, engagement level determiner 297 can analyze the occurrences of the events to determine, for each user of a plurality of the users, an engagement level of the user with the project.

At block 510, method 500 includes assigning the user to a role using the engagement level. For example, role identifier 292 can assign the user a role for the project from predefined roles based on applying a role feature corresponding to the engagement level of the user to a machine learning model that represents the role.

At block 512, method 500 includes determining content related to the project based on the assignment of the user to the role. For example, interface manager 260 can personalize content to the user based on the assignment of the role to the user. The personalized content can be presented on a user device using presentation component 220 such as by transmitting the personalized content to the user device and presenting the content in association with the user, as one example.

It is understood that various features, sub-combinations, and modifications of the embodiments described herein are of utility and may be employed in other embodiments without reference to other features or sub-combinations. Moreover, the order and sequences of steps shown in the example methods 300, 400, and 500 are not meant to limit the scope of the present invention, and in fact, the steps may occur in a variety of different sequences within embodiments hereof. Such variations and combinations thereof are also contemplated to be within the scope of embodiments of the invention.

Having described various embodiments of the invention, an example computing environment suitable for implementing embodiments of the invention is now described. With reference to FIG. 6, an example computing device is provided and referred to generally as computing device 600. The computing device 600 is but one example of a suitable computing environment and is not intended to suggest any limitation as to the scope of use or functionality of the invention. Neither should the computing device 600 be interpreted as having any dependency or requirement relating to any one or combination of components illustrated.

Embodiments of the invention may be described in the general context of computer code or machine-usable instructions, including computer-usable or computer-executable instructions, such as program modules, being executed by a computer or other machine, such as a personal data assistant, a smartphone, a tablet PC, or other handheld device. Generally, program modules, including routines, programs, objects, components, data structures, and the like, refer to code that performs particular tasks or implements particular abstract data types. Embodiments of the invention may be practiced in a variety of system configurations, including handheld devices, consumer electronics, general-purpose computers, more specialty computing devices, etc. Embodiments of the invention may also be practiced in distributed computing environments where tasks are performed by remote-processing devices that are linked through a communications network. In a distributed computing environment, program modules may be located in both local and remote computer storage media including memory storage devices.

With reference to FIG. 6, computing device 600 includes a bus 610 that directly or indirectly couples the following devices: memory 612, one or more processors 614, one or more presentation components 616, one or more input/output (I/O) ports 618, one or more I/O components 620, and an illustrative power supply 622. Bus 610 represents what may be one or more busses (such as an address bus, data bus, or combination thereof). Although the various blocks of FIG. 6 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art and reiterate that the diagram of FIG. 6 is merely illustrative of an example computing device that can be used in connection with one or more embodiments of the present invention. Distinction is not made between such categories as “workstation,” “server,” “laptop,” “handheld device,” etc., as all are contemplated within the scope of FIG. 6 and with reference to “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 600. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 612 includes computer storage media in the form of volatile and/or nonvolatile memory. The memory may be removable, non-removable, or a combination thereof. Example hardware devices include solid-state memory, hard drives, optical-disc drives, etc. Computing device 600 includes one or more processors 614 that read data from various entities such as memory 612 or I/O components 620. Presentation component(s) 616 presents data indications to a user or other device. Example presentation components include a display device, speaker, printing component, vibrating component, and the like.

The I/O ports 618 allow computing device 600 to be logically coupled to other devices, including I/O components 620, some of which may be built in. Illustrative components include a microphone, joystick, game pad, satellite dish, scanner, printer, wireless device, etc. The I/O components 620 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 600. The computing device 600 may be equipped with depth cameras, such as stereoscopic camera systems, infrared camera systems, RGB camera systems, and combinations of these, for gesture detection and recognition. Additionally, the computing device 600 may be equipped with accelerometers or gyroscopes that enable detection of motion. The output of the accelerometers or gyroscopes may be provided to the display of the computing device 600 to render immersive augmented reality or virtual reality.

Some embodiments of computing device 600 may include one or more radio(s) 624 (or similar wireless communication components). The radio 624 transmits and receives radio or wireless communications. The computing device 600 may be a wireless terminal adapted to receive communications and media over various wireless networks. Computing device 600 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include, by way of example and not limitation, a Wi-Fi® connection to a device (e.g., mobile hotspot) that provides access to a wireless communications network, such as a WLAN connection using the 802.11 protocol; a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

Many different arrangements of the various components depicted, as well as components not shown, are possible without departing from the scope of the claims below. Embodiments of the present invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility, may be employed without reference to other features and sub-combinations, and are contemplated within the scope of the claims.

What is claimed is:

1. A computer-implemented system, comprising:
one or more processors; and
one or more computer-readable storage media containing instructions which when executed on the one or more processors, cause the one or more processors to perform a method comprising:
determining, from user activity data from sensor data from at least one user device, entity features of project entities;
grouping the project entities into projects based at least in part on patterns formed by the entity features between the project entities;
determining, from content of the project entities of a project of the projects, occurrences of events with respect to users, each event corresponding to one or more predefined user activities;
analyzing the occurrences of the events to determine, for each user of a plurality of the users, an engagement level of the user with the project;
assigning a user a role for the project from predefined roles based on applying a role feature corresponding to the engagement level of the user to a machine learning model that represents the role, each of the predefined roles represented by a corresponding machine learning model that uses a different set of role features;
based on the assigning of the user to the role, incorporating an assignment of the user to the role into a project repository of the project, the project repository comprising assignments between users and the predefined roles for the project; and
determining, based on one or more of the assignments in the project repository, a notification in association with the project.

2. The computer-implemented system of claim 1, wherein the project entities comprise emails, meetings, and files.

3. The computer-implemented system of claim 1, wherein the engagement level is based on a frequency of the occurrences of the events for the user.

4. The computer-implemented system of claim 1, wherein a plurality of the predefined roles correspond to different magnitudes of engagement levels with the project.

5. The computer-implemented system of claim 1, wherein the project repository includes engagement levels of users for the project, and the determining the notification is further based on one or more of the engagement levels in the project repository.

6. The computer-implemented system of claim 1, wherein the machine learning model for the role uses an additional role feature corresponding to the occurrences of an event of the events for the user, the event comprising the user setting one or more priorities for the project.

7. The computer-implemented system of claim 1, wherein the machine learning model for the role uses an additional role feature corresponding to the occurrences of an event of the events for the user, the event comprising the user producing content of an output of the project.

8. The computer-implemented system of claim 1, wherein the machine learning model for the role uses an additional role feature corresponding to the occurrences of an event of the events for the user, the event comprising the user assigning a task of the project to one or more other users.

9. The computer-implemented system of claim 1, wherein the machine learning model for the role uses an additional role feature corresponding to the occurrences of an event of the events for the user, the event comprising the user providing feedback on one or more aspects of the project.

10. The computer-implemented system of claim 1, determining importance levels for the occurrences of the events based on project state categories assigned to the occurrences of the events, wherein the machine learning model for the role uses an additional role feature that is based on the importance levels for the occurrences of the events that are associated with the user.

11. The computer-implemented system of claim 1, determining importance levels for the occurrences of the events based on content subject matter categories assigned to the occurrences of the events, wherein the machine learning model for the role uses an additional role feature that is based on a variance in the content subject matter categories for the occurrences of the events that are associated with the user.

12. The computer-implemented system of claim 1, wherein the machine learning model for the role uses an additional role feature corresponding to an event of the user receiving an output of the project.

13. The computer-implemented system of claim 1, wherein the determining the notification in association with the project comprises:
associating a meeting with the project based on comparing project characteristics of the project to meeting context of the meeting; and
based on the meeting context of the meeting and the role of the user, selecting the user as an attendee for the meeting, wherein the notification is based on the selecting of the user as the attendee.

14. One or more computer storage media storing computer-usable instructions that, when executed by one or more computing devices, cause the one or more computing devices to perform a method comprising:
determining, from user activity data from sensor data from at least one user device, entity features of project entities, the entity features including for each project entity of a plurality of the project entities, a set of users associated with the project entity;
grouping the project entities into projects based at least in part on patterns formed by the set of users between the project entities;
determining, from content of the project entities of a project of the projects, occurrences of events with respect to users, each event corresponding to one or more predefined user activities;
assigning a user a role for the project from predefined roles based on applying a role feature corresponding to the occurrences for at least one event of the events that are associated with the user to a machine learning model that represents the role, each of the predefined roles represented by a corresponding machine learning model that uses a different set of role features that corresponds to a different set of the events than others of the predefined roles; and
determining content related to the project based on the assigning of the user to the role.

15. The one or more computer storage media of claim 14, wherein the determining the content related to the project comprises:
identifying an absence of the user in a confirmed attendee list of a meeting associated with the project; and
based on the identifying of the absence of the user in the confirmed attendee list, and based on the meeting context of the meeting and the role of the user, automatically determining an alternate meeting time for the meeting using a calendar associated with the user.

16. The one or more computer storage media of claim 14, wherein the determining the content related to the project comprises ranking a plurality of emails by similarity to content subject matter categories based on the role of the user and by project characteristics of the project, wherein the method further causes displaying one or more of the plurality of the emails to the user in an inbox based on the ranking of the plurality of the emails.

17. A computer-implemented method, comprising:
grouping project entities into projects based at least in part on similarities between entity features between the project entities;
determining, from content of the project entities of a project of the projects, occurrences of events with respect to users, each event corresponding to one or more predefined user activities;
analyzing the occurrences of the events to determine, for each user of a plurality of the users, an engagement level of the user with the project;
assigning a user a role for the project from predefined roles based on applying a role feature corresponding to the engagement level of the user to a machine learning model that represents the role; and
determining content related to the project based on the assigning of the user to the role.

18. The method of claim 17, further comprising analyzing the occurrences of the events to determine, for each user of a plurality of the users, an engagement level of the user with the project, wherein the machine learning model for the role uses an additional role feature corresponding to the engagement level of the user.

19. The method of claim 17, wherein the machine learning model for the role uses an additional role feature corresponding to the occurrences of an event of the events for the user, the event comprising the user setting one or more priorities for the project.

20. The method of claim 17, wherein the machine learning model for the role uses an additional role feature corresponding to the occurrences of an event of the events for the user, the event comprising the user producing content of an output of the project.
